(19) United States
(12) Patent Application Publication
(10) Pub. No.: US 2024/0281867 A1
(43) Pub. Date: Aug. 22, 2024

(54) MODIFIED PEER-TO-PEER PLATFORMS AND PLATFORM SERVICES FOR ENHANCING COLLABORATION WITHIN A DIGITAL ECOSYSTEM

(71) Applicant: Donation Download LLC, Apple Valley, MN (US)

(72) Inventor: Garth HECKMAN, Apple Valley, MN (US)

(21) Appl. No.: 18/442,880

(22) Filed: Feb. 15, 2024

Related U.S. Application Data
(60) Provisional application No. 63/485,728, filed on Feb. 17, 2023.

(51) Int. Cl. G06Q 30/0601; G06Q 20/38

(52) U.S. Cl. CPC G06Q 30/0633; G06Q 20/389; G06Q 30/0641

(57) ABSTRACT

Various embodiments of the present disclosure provide collaboration platforms and platform services for improving collaboration within a digital ecosystem. The techniques include leveraging hidden variables within a data item to preemptively lock a submission process. In this manner, traditional biases within a digital ecosystem may be avoided. Other collaboration platform features may include temporary tracking services, among others, that enhance the safety of collaboration within a digital environment.

### CROSS-REFERENCE TO RELATED APPLICATIONS

This application claims the benefit of U.S. Provisional Application No. 63/485,728, entitled “Systems, Methods, Components, and Software for Online Selling And Shopping,” and filed Feb. 17, 2023, the entire contents of which are herein incorporated by reference.

This application is also related to U.S. Provisional Patent Application No. 62/679,131, which was filed Jun. 1, 2018, and is incorporated herein by reference in its entirety.

### TECHNICAL FIELD

Various embodiments of the present disclosure relate generally to peer-to-peer and other network platforms for facilitating communication between individuals within a digital ecosystem, such as an online marketplace.

### BACKGROUND

Traditional peer-to-peer platforms may facilitate various types of commercial activity between users within a digital ecosystem. Examples include bidding and auction platforms, classified listing platforms, and/or the like. Traditionally, such platforms offer limited tools for controlling collaboration between users within the digital ecosystem, which may lead to bias, scams, cyberbullying, and other abuses proliferated by unfettered network communications. For example, traditional Internet-based auction sites may be biased to promote the interests of sellers at the expense of buyers. For instance, traditional peer-to-peer marketplace platforms allow a seller to set a reserve price, or minimum acceptable bid, for an item without enabling a maximum acceptable bid. This leads to bidding wars in which a winning submitting user (e.g., the buyer) may pay more than the fair market value of an item.

As another example, items sold on peer-to-peer platforms traditionally require submitting users to physically inspect an item prior to acceptance. For larger items with relatively high shipping expense relative to the value of the item, these inspections require a physical touchpoint between two otherwise anonymous users. This anonymity, provided by the Internet, may lead to potentially dangerous, untracked physical touchpoints between users of the traditional platforms, which limits the accessibility of peer-to-peer marketplaces due to safety constraints.

Various embodiments of the present disclosure make important contributions to traditional digital ecosystems by addressing these technical challenges, among others.

### BRIEF SUMMARY

To address the above identified challenges, among others, some embodiments of the present disclosure provide modified platforms and platform services for enhancing collaboration between users within a digital ecosystem. For example, some embodiments of the present disclosure include bid locking services for preemptively concluding a bidding process (e.g., locking a bid) based on a predetermined acceptable sale price. As another example, some embodiments of the present disclosure include real-time tracking and location selection services for monitoring user activity in the physical world during a physical touchpoint facilitated by an online platform. Still other embodiments of the present disclosure describe radius-based searching for improving the relevance of item searches, bid tracking services for monitoring the real-time progress of several concurrent bid items, alerting services for providing alerts based on bidding activity, ambiance services for personalizing a digital ecosystem to a user, compulsory rating services for enforcing accountability across a peer-to-peer marketplace, delayed exchange services for synchronizing different portions of a transaction (e.g., synchronize payment with acceptance of goods, etc.), seller profiling services for tracking individual seller activity, as well as blockchain enhancements for improving accountability within a digital ecosystem.

In some embodiments, computer-implemented method for leveraging integrated blockchain platform mechanisms to establish secure network exchanges through a combination of centralized and distributed devices comprises receiving, by one or more processors and through a browsing interface screen, an item selection input corresponding to a data item, wherein (i) the data item comprises one or more visible attributes and one or more hidden attributes and (ii) one of the one or more hidden attributes identifies a locking threshold for the data item; responsive to the item selection input, providing for display, by the one or more processors and through an item interface screen, the one or more visible attributes for the data item; receiving, by the one or more processors and through the item interface screen, an item submission input that identifies a submitted value for the data item; responsive to a determination that the submitted value satisfies the locking threshold, updating, by the one or more processors, an item availability of the data item; generating, by the one or more processors, a candidate distributed ledger entry indicative of the data item, a listing member associated with the data item, the item submission input, and a submitting member associated with the item submission input; and providing, by the one or more processors, the candidate distributed ledger entry to one or more distributed computing devices, wherein the candidate distributed ledger entry is added to a platform distributed ledger.

In some examples, (i) the one or more visible attributes comprise an item status that identifies an interactivity the data item, (ii) the item status for the data item reflects an available status for the data item, and (iii) updating the item availability of the data item comprises modifying the item status to reflect an unavailable status for the data item.

In some examples, the one or more visible attributes comprise a locking indicator attribute corresponding to the locking threshold and visually indicating that the data item is associated with the locking threshold without identifying a hidden submission locking value of the locking threshold.

In some examples, the item submission input is provided through an interactive submission icon of the item interface screen and the computer-implemented method further comprises responsive to the determination that the submitted value satisfies the locking threshold, modifying an interactivity parameter of the interactive submission icon to disable a subsequent item submission input.

In some examples, the data item corresponds to a digital item and the candidate distributed ledger entry comprises a digital watermark for the digital item. For example, the collaboration platform may facilitate an exchange of a digital item.

In some examples, the candidate distributed ledger entry comprises a plurality of Internet Protocol (IP) addresses respectively corresponding to the listing member, the submitting member, and a third-party computing entity that facilitates a download of the digital item. For example, the collaboration platform may facilitate an exchange of a digital item by creating and/or updating one or more blockchain ledger entries in response to an exchange and/or download of a digital item. In some examples, each distributed ledger entry may include a digital watermark for the digital item.

In some examples, the computer-implemented method further comprises providing for display, through a location interface screen, one or more selectable location icons that respectively identify one or more locations for accessing an item corresponding to the data item; receiving, through the location interface screen, a location selection identifying a location of the one or more locations; and providing one or more instructions to a listing member associated with the data item and a submitting member associated with the item submission input.

In some examples, the (i) the location interface screen is provided for display in response to an inspection attribute associated with the data item; and (ii) the one or more instructions reflect an exchange time and exchange address for an inspection of the item.

In some examples, the location interface screen comprises a location tracking request icon, and the computer-implemented method further comprises receiving, through the location interface screen, a selection of the location tracking request icon; responsive to the selection and based on a proximity of a current time to the exchange time, receiving (i) listing member location data from a listing member computing device associated with the listing member and (ii) submitting member location data from a submitting member computing device associated with the submitting member; and temporarily providing (i) the listing member location data to the submitting member computing device and (ii) the submitting member location data to the listing member computing device.

In some examples, (i) the one or more visible attributes for the data item comprise a minimum submission value, a current submission value, and a visible locking submission value, and (ii) the locking threshold comprises a hidden submission locking value that is between the minimum submission value and the visible locking submission value.

In some examples, the one or more visible attributes comprise a member rating identifier for a listing member corresponding to the data item.

In some examples, the computer-implemented method further comprises performing an initial transaction operation to (i) deduct the submitted value from a submitting account associated with a submitting member and (ii) store the submitted value in an intermediary account; receiving a completed transaction input from the submitting member; and responsive to the completed transaction input, performing a secondary transaction operation to (i) deduct the submitted value from the intermediary account and (ii) provide the submitted value to a listing account associated with a listing member.

In some examples, the completed transaction input is responsive to a verified physical inspection of a physical item corresponding to the data item.

In some embodiments, a computing system for leveraging integrated blockchain platform mechanisms to establish secure network exchanges through a combination of centralized and distributed devices is provided. The computing system comprises memory and one or more processors communicatively coupled to the memory, the one or more processors are configured to receive, through a browsing interface screen, an item selection input corresponding to a data item, wherein (i) the data item comprises one or more visible attributes and one or more hidden attributes and (ii) one of the one or more hidden attributes identifies a locking threshold for the data item; responsive to the item selection input, provide for display, through an item interface screen, the one or more visible attributes for the data item; receive, through the item interface screen, an item submission input that identifies a submitted value for the data item; responsive to a determination that the submitted value satisfies the locking threshold, update an item availability of the data item, generate a candidate distributed ledger entry indicative of the data item, a listing member associated with the data item, the item submission input, and a submitting member associated with the item submission input; and provide the candidate distributed ledger entry to one or more distributed computing devices, wherein the candidate distributed ledger entry is added to a platform distributed ledger.

In some examples, (i) the one or more visible attributes comprise an item status that identifies an interactivity the data item, (ii) the item status for the data item reflects an available status for the data item, and (iii) updating the item availability of the data item comprises modifying the item status to reflect an unavailable status for the data item.

In some examples, the one or more visible attributes comprise a locking indicator attribute corresponding to the locking threshold and visually indicating that the data item is associated with the locking threshold without identifying a hidden submission locking value of the locking threshold.

In some examples, the item submission input is provided through an interactive submission icon of the item interface screen and the one or more processors are further configured to responsive to the determination that the submitted value satisfies the locking threshold, modify an interactivity parameter of the interactive submission icon to disable a subsequent item submission input.

In some embodiments, one or more non-transitory computer-readable storage media for leveraging integrated blockchain platform mechanisms to establish secure network exchanges through a combination of centralized and distributed devices, the one or more non-transitory computer-readable storage media comprising instructions that, when executed by one or more processors, cause the one or more processors to receive, through a browsing interface screen, an item selection input corresponding to a data item, wherein (i) the data item comprises one or more visible attributes and one or more hidden attributes and (ii) one of the one or more hidden attributes identifies a locking threshold for the data item; responsive to the item selection input, provide for display, through an item interface screen, the one or more visible attributes for the data item; receive, through the item interface screen, an item submission input that identifies a submitted value for the data item; responsive to a determination that the submitted value satisfies the locking threshold, update an item availability of the data item, generate a candidate distributed ledger entry indicative of the data item, a listing member associated with the data item, the item submission input, and a submitting member associated with the item submission input; and provide the candidate distributed ledger entry to one or more distributed computing devices, wherein the candidate distributed ledger entry is added to a platform distributed ledger.

In some examples, the instructions further cause the one or more processors to perform an initial transaction operation to (i) deduct the submitted value from a submitting account associated with a submitting member and (ii) store the submitted value in an intermediary account; receive a completed transaction input from the submitting member; and responsive to the completed transaction input, perform a secondary transaction operation to (i) deduct the submitted value from the intermediary account and (ii) provide the submitted value to a listing account associated with a listing member.

### BRIEF DESCRIPTION OF THE DRAWINGS

FIG. 1 provides an example overview of an architecture in accordance with some embodiments of the present disclosure.

FIG. 2 provides an example collaboration computing system in accordance with some embodiments of the present disclosure.

FIG. 3 provides an example member computing device in accordance with some embodiments of the present disclosure.

FIG. 4 is a flowchart diagram of an example process for generating a de-biased data item listing in accordance with some embodiments discussed herein.

FIGS. 5A-F provide example interface screens for facilitating a data item listing in accordance with some embodiments discussed herein.

FIG. 6 is a flowchart diagram of an example process for facilitating a secure exchange in accordance with some embodiments discussed herein.

FIG. 7 is a flowchart diagram of an example process for removing bias from a peer-to-peer digital marketplace in accordance with some embodiments discussed herein.

FIG. 8 is a flowchart diagram of an example process for improving safety in a peer-to-peer digital marketplace in accordance with some embodiments discussed herein.

FIG. 9 is a flowchart diagram of an example process for enforcing accountability in a peer-to-peer digital marketplace in accordance with some embodiments discussed herein.

FIGS. 10A-E provide example interface screens for facilitating a data item exchange in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Computing Ecosystem

The following discussion provides example computing entities of an embodiment of a collaborative, multi-entity system that provides services, tools, and other functionalities for removing bias, enhancing safety and credibility, among other improvements to traditional collaboration platforms.

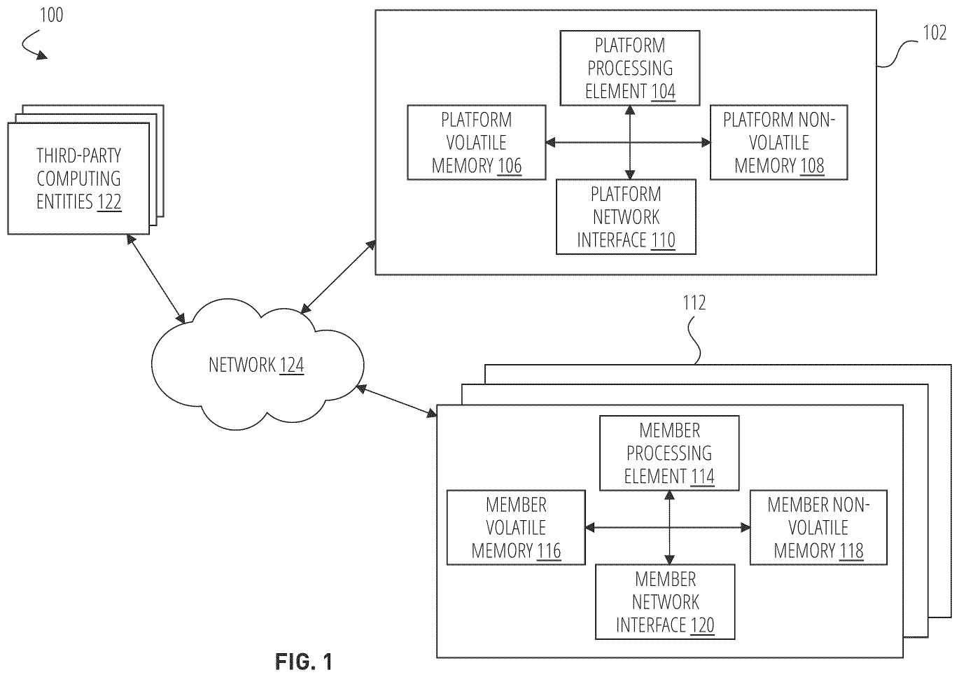

FIG. 1 provides an example overview of an architecture 100 in accordance with some embodiments of the present disclosure. The architecture 100 includes a collaboration platform 102 configured to provide one or more collaborative computing services to a plurality of member computing devices 112. The collaboration platform 102, for example, may host a collaborative computing environment, such as peer-to-peer marketplace, that may be accessible to a plurality of member computing devices 112. The example architecture 100 may be used in a plurality of domains and not limited to any specific application as disclosed herewith. The plurality of domains may include electronic commerce, banking, healthcare, industrial, manufacturing, education, retail, to name a few.

In some embodiments, the collaboration platform 102 may communicate with at least one of the member computing devices 112 using one or more communication networks 124. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The collaboration platform 102 and/or member computing devices 112 may also communicate with one or more third-party computing entities 122. The third-party computing entities 122, for example, may include one or more third-party databases, intermediary computing entities, and/or the like.

In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes may be performed on data, content, information, and/or similar terms used herein interchangeably.

As shown in FIG. 1, in some embodiments, the collaboration platform 102 may include, or be in communication with, one or more platform processing elements 104 (also referred to as processors, processing circuitry, and/or similar terms used herein interchangeably) that communicate with other elements within the collaboration platform 102 via a bus, for example. As will be understood, the platform processing element 104 may be embodied in a number of different ways.

For example, the platform processing element 104 may be embodied as one or more complex programmable logic devices (CPLDs), microprocessors, multi-core processors, coprocessing entities, application-specific instruction-set processors (ASIPs), microcontrollers, and/or controllers. Further, the platform processing element 104 may be embodied as one or more other processing devices or circuitry. The term circuitry may refer to an entirely hardware embodiment or a combination of hardware and computer program products. Thus, the platform processing element 104 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the platform processing element 104 may be configured for a particular use or configured to execute instructions stored in volatile or non-volatile media or otherwise accessible to the platform processing element 104. As such, whether configured by hardware or computer program products, or by a combination thereof, the platform processing element 104 may be capable of performing steps or operations according to embodiments of the present disclosure when configured accordingly.

In some embodiments, the collaboration platform 102 may further include, or be in communication with, non-volatile media (also referred to as non-volatile storage, memory, memory storage, memory circuitry, and/or similar terms used herein interchangeably). In some embodiments, the non-volatile media may include one or more platform non-volatile memory 108, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the collaboration platform 102 may further include, or be in communication with, volatile media (also referred to as volatile storage, memory, memory storage, memory circuitry, and/or similar terms used herein interchangeably). In some embodiments, the volatile media may also include one or more platform volatile memory 106, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies computer functions described herein, executable instructions, and/or the like being executed by, for example, the platform processing element 104. Thus, the databases, database instances, database management systems, data, applications, programs, program modules, code (source code, object code, byte code, compiled code, interpreted code, machine code) that embodies computer functions described herein, executable instructions, and/or the like may be used to control certain aspects of the operation of the collaboration platform 102 with the assistance of the platform processing element 104 and operating system.

As indicated, in some embodiments, the collaboration platform 102 may also include one or more platform network interfaces 110 for communicating with various computing entities (e.g., the member computing devices 112, third-party computing entities 122, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the collaboration platform 102 communicates with another computing entity for uploading or downloading data or code. Similarly, the collaboration platform 102 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the collaboration platform 102 may include, or be in communication with, one or more input elements, such as a keyboard input, a mouse input, a touch screen/display input, motion input, movement input, audio input, pointing device input, joystick input, keypad input, and/or the like. The collaboration platform 102 may also include, or be in communication with, one or more output elements (not shown), such as audio output, video output, screen/display output, motion output, movement output, and/or the like.

As shown in FIG. 1, the member computing device 112 may include one or more processing elements 114 (e.g., processors, CPLDs, microprocessors, multi-core processors, coprocessing entities, ASIPs, microcontrollers, and/or controllers) that may communicate (e.g., via internal circuitry, such as a bus, etc.) with memory and/or a member network interface 120 (e.g., transmitters, receivers, etc.). Signals, for example, may be provided to and/or received from the member network interface to communicate, via one communication networks 124, with the collaboration platform 102 and/or one or more third-party computing entities 122.

The signaling information/data may be communicated in accordance with air interface standards of applicable wireless systems. In this regard, the member computing device 112 may be capable of operating with one or more air interface standards, communication protocols, modulation types, and access types. More particularly, the member computing device 112 may operate in accordance with any of a number of wireless communication standards and protocols, such as those described above with regard to the collaboration platform 102. In some embodiments, the member computing device 112 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the member computing device 112 may operate in accordance with multiple wired communication standards and protocols, such as those described above with regard to the collaboration platform 102 via the member network interface.

Via these communication standards and protocols, the member computing device 112 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The member computing device 112 may also download code, changes, add-ons, and updates, for instance, to its firmware, software (e.g., including executable instructions, applications, program modules), and operating system.

According to some embodiments, the member computing device 112 may include location determining aspects, devices, modules, functionalities, and/or similar words used herein interchangeably. For example, the member computing device 112 may include outdoor positioning aspects, such as a location module adapted to acquire, for example, latitude, longitude, altitude, geocode, course, direction, heading, speed, universal time (UTC), date, and/or various other information/data. In some embodiments, a location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the member computing device 112 in connection with a variety of other systems, including cellular towers, Wi-Fi access points, and/or the like. Similarly, the member computing device 112 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The member computing device 112 may also include member volatile memory 116 and/or member non-volatile memory 118, which may be embedded and/or may be removable. For example, the member non-volatile memory 118 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The member volatile memory 116 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies computer functions described herein, executable instructions, and/or the like to implement the functions of the member computing device 112. As indicated, this may include a user application that is resident on the member computing device 112 or accessible through a browser or other user interface for communicating with the collaboration platform 102 and/or various other computing entities.

In another embodiment, the member computing device 112 may include one or more components or functionalities that are the same or similar to those of the collaboration platform 102, as described in greater detail above. In one such embodiment, the member computing device 112 downloads, e.g., via member network interface 120, code from the collaboration platform 102 so that the member computing device 112 may run a local instance of one or more computing functions described herein. As will be recognized, these architectures and descriptions are provided for example purposes only and are not limited to the various embodiments.

In various embodiments, the member computing device 112 may be embodied as an artificial intelligence (AI) computing entity, such as an Amazon Echo, Amazon Echo Dot, Amazon Show, Google Home, and/or the like. Accordingly, the member computing device 112 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Example Collaboration System

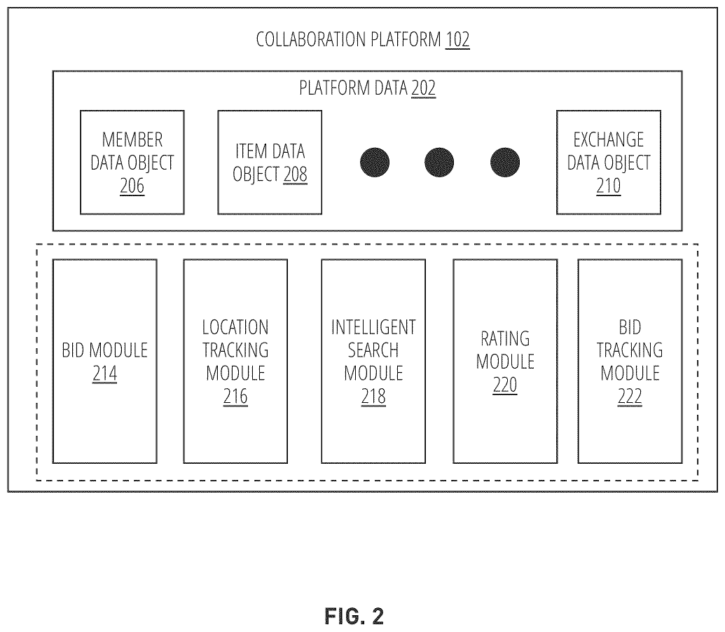

FIG. 2 provides a functional example collaboration platform 102 in accordance with some embodiments of the present disclosure. As depicted, the collaboration platform 102 may include a platform data 202 and a plurality of platform modules 204 collectively configured to facilitate a collaborative environment. The collaborative environment, for example, may include a peer-to-peer marketplace in which a plurality of members may interact to exchange tangible and/or intangible items.

The platform data 202 may include various types of data objects associated with one or more members, data items, and/or any other data entity associated with the collaborative environment. The platform data 202 and/or the data objects thereof may be stored in any type of data structure, including relational databases, graph databases, distributed ledgers, and/or the like.

In some examples, the data objects may include member data objects 206, item data objects 208, exchange data objects 210, among others. Each of the plurality of data object may include a plurality of attributes and each attribute may include one or more attribute parameters. An attribute parameter, for example, may identify a visibility and/or one or more other constraints of an attribute. For example, the plurality of attributes for a data object may include one or more visible attributes and/or one or more hidden attributes. The one or more visible attributes may include an attribute parameter that enables a visibility of the attribute to one or more members of the collaboration platform 102. The one or more hidden attributes may include an attribute parameter that disables a visibility of the attribute to one or more members of the collaboration platform 102. In some examples, attributes may be dynamically modified to change a visible attribute to a hidden attribute.

In some embodiments, a member data object 206 corresponds to a member of a collaboration platform 102. A member data object 206 may include a plurality of member attributes for a particular member, including a member name (e.g., legal name, username, screenname, etc.), member credentials (e.g., two-factor authentication credentials, persistent security code, password, etc.), member location data (e.g., physical address, current location, virtual address, IP address, etc.), member ratings, member preferences, member payment accounts, and/or the like. The plurality of member attributes may be preset and/or dynamically updated over time. For instance, the member location data may include a preset physical mailing address and/or a dynamically set current location that may be dynamically determined at a defined frequency based on sensor data from a member computing device associated with a member.

In some examples, a member data object 206 may be associated with one or more item data objects. For instance, the member data object 206 may include a plurality of listing item attributes that respectively identify one or more data items listed by a particular member.

In some examples, the member data object 206, and/or one or more attributes thereof, may be stored in one or more distributed ledger entries of a distributed ledger. For example, an initial entry may be posted to a distributed ledger responsive to a creation of a new member account with the collaboration platform 102. Thereafter, a new distributed ledger entry may be continuously generated and posted based on one or more new and/or modified member attributes, such as an updated current location, and/or the like.

In some embodiments, an item data object 208 corresponds to a data item for a physical and/or digital item. An item data object 208 may include a plurality of item attributes for a particular data item, including an item name (e.g., registered name, etc.), item description, item media (e.g., pictures, music samples, etc.), item location data (e.g., physical address, current location, etc.), item value parameters (e.g., hidden submission locking value, minimum submission value, the visible locking submission value, etc.), and/or the like. The plurality of item attributes may be preset and/or dynamically updated over time. For instance, the item location data may include a preset physical address and/or a dynamically set current location that may be dynamically determined at a defined frequency based on sensor data from an item tracking device.

In some examples, an item data object 208 may be associated with one or more member data objects. For instance, the item data object 208 may include a plurality of item member attributes that respectively identify one or more listing and/or submitting members for a corresponding data item.

In some examples, the item data object 208, and/or one or more attributes thereof, may be stored in one or more distributed ledger entries of a distributed ledger. For example, an initial entry may be posted to a distributed ledger responsive to a creation of a new item listing with the collaboration platform 102. Thereafter, a new distributed ledger entry may be continuously generated and posted based on one or more new and/or modified item attributes, such as an updated value parameter, and/or the like.

In some embodiments, an exchange data object 210 corresponds to an exchange between two members of the collaboration platform 102 for a data item. An exchange data object 210 may include a plurality of exchange attributes, including an item identifier reflective of an item data object, one or more member identifiers corresponding to a listing and/or submitting member of the exchange, an accepted submitting value, one or more submitting value payment schedules, inspection and/or pick-up location data, and/or the like. The plurality of exchange attributes may be preset and/or dynamically updated over time. For instance, the exchange location data may include a preset physical address reflective of a selected exchange location and/or a dynamically set current location that may be dynamically determined at a defined frequency based on sensor data from one or member computing devices associated with the exchange.

In some examples, the exchange data object 210, and/or one or more attributes thereof, may be stored in one or more distributed ledger entries of a distributed ledger. For example, an initial entry may be posted to a distributed ledger responsive to an acceptance of an item submission through the collaboration platform 102. Thereafter, a new distributed ledger entry may be continuously generated and posted based on one or more new and/or modified exchange attributes, such as updated location data for members as they travel to an inspection and/or pick-up location.

In some embodiments, the collaboration platform 102 may include a plurality of platform modules 204 respectively configured to facilitate at least one aspect of a collaborative environment. Each of the plurality of platform modules 204, for example, may include computer-readable instructions that, when executed by one or more processors, cause the one or more processors to perform one or more functions described herein. In some examples, the computer-readable instructions are stored in one or more platform memory devices. In addition, or alternatively, computer-readable instructions may be distributed across one or more platform memory devices, one or more third-party computing entities, and/or one or more member computing devices. Thus, one or more functionalities, and/or portions thereof, associated by a respective platform module may be performed by the collaboration platform 102, one or more third-party computing entities, one or more member computing devices, and/or one or more combinations thereof.

The plurality of platform modules 204 may include any number of different modules for facilitating and enhancing a digital collaborative environment. As some examples, the plurality of platform modules 204 may include a bid module 214 configured to facilitate a specialized bidding process for removing bias from traditional peer-to-peer digital marketplaces, a location tracking module 216 configured to counteract anonymity inherent in a digital environment through safe location tracking mechanisms, an intelligent search module 218 configured to enhance search results and alerts for members, a rating module 220 configured to improve reliability of exchanges between peers within a digital environment, and a bid tracking module 222 configured to leverage blockchain enhancement to track a multi-stage bidding process.

In some embodiments, the bid module 214 is configured to facilitate an end-to-end bidding process that reduces seller abuse inherent in traditional electronic bidding systems. For example, the bid module 214 may implement one or more de-biasing services, such as bid locking services, bid tracking services, value modification alerting service, media publishing services, the cross-item incentive services, intermediary exchange services, cross-platform services, value determination services, and/or the like.

In some embodiments, the bid locking service may be configured to lock a data item responsive to the reception of a submission with a submission value that achieves a hidden locking threshold. A submission, for example, may include a proposal, from a submitting user, to provide a submission value in exchange for an item corresponding to a data item. The hidden locking threshold may include a pre-set hidden submission locking value that established a minimum submission value required in exchange for the item. In some examples, the hidden locking threshold may be based on a fair market value of an item corresponding to the data item. In this way, the hidden locking threshold may prevent listing users from inducing competing members into bidding wars that far exceed an actual value of the item.

For example, when a data item (e.g., a product, service, media content, graphics, etc.) is generated for a published listing, the listing member may be prompted to set a minimum acceptable sale price (e.g., a hidden submission locking value) to conclude an auction for the item, with conclusion meaning that the data item is removed from a list of items on sale and no further bidding activity is accepted for the item. In some examples, contingent bidding may continue until an exchange for the item is complete. At this point the amount is locked-in, and the listing and submitting members may begin to communicate (e.g., via one or more platform peer-to-peer communication tools, etc.) to arrange a physical and/or digital exchange.

In some embodiments, the bid tracking service includes a multi-faceted approach to improve the transparency within an electronic commerce environment. The bid tracking service, for example, may provide an alert to a listing member in response to a submission by a submitting member. In response to the submission achieving a threshold submission value, such as a hidden locking threshold and/or visible locking threshold, the alert may include exchange location instructions for performing a physical exchange. The exchange location instructions, for example, may include a pick-up time, pick-up date, and/or pick-up location. In some examples, the listing member may request one or more modifications to the exchange location instructions, in which case a response may be provided to the submitting member. In addition, or alternatively, in response to the submission not achieving a threshold submission value, such as the hidden and/or visible locking threshold, the alert may include a request to accept a lower submission value.

The listing user may respond by accepting or declining the submission. The bid tracking service may store each of these submissions (e.g., those that achieve and do not achieve a threshold) in a listing member profile. For example, the submissions may be tracked on the listing member's home page showing a number of submissions, the submission values for each of the submission, and/or a time corresponding to the submissions. This allows a listing user and/or a submitting user to better understand the market value of an item and perform a value modification for modifying one or more value parameters based on the market value.

In some embodiments, the value modification alerting service enables a listing member to provide push notifications to other members within the collaborative computing environment to selectively publish a value modification to interested users. For example, when a listing member modifies a value parameter for a data item, the value modification alerting service may provide a notification to all previously submitting members for the data item. In this manner, previously unsuccessful submitting members may be recaptured.

In some embodiments, the media publishing service enables a listing user to publish media-based data items for use by users within the collaborative computing environment. By way of example, the media publishing mechanism may publish media-based data items, such as music, video, podcast, audio book, and/or the like to a radio station for playback while a user browses a peer-to-peer marketplace. For example, when a listing member loads his music for sale within the collaborative computing environment, the media publishing service may prompt the listing user to provide one or more attributes (e.g., genre, etc.) for the music and then prompt the user for access to a platform radio station. In response to a positive response from the listing user, the media publishing service may upload the music to a platform radio station that is accessible by one or more browsing users within the collaborative computing environment.

In some embodiments, the intermediary exchange service enables access to secure escrow platforms to facilitate an exchange. For example, when a listing member generated a data item, the intermediary exchange service may prompt the member to use an escrow service to allow for risk-free shipping of an item. If accepted, responsive to an accepted submission, the listing member and the submitting member may set up a value of exchange through an intermediary, escrow service. After an item is shipped the value of exchange may be stored by an intermediary account for a threshold number of days as the submitting user inspects the item. After a successful inspection, the value of exchange may be provided from the intermediary account to a listing member account. After an unsuccessful inspection, the value of exchange may be held in the intermediary account and provided to the submitting member's account after the item is returned to the listing member.

In some examples, the intermediary exchange service may enable a multi-stage exchange of value. The multi-stage exchange of value, for example, may be leveraged by data items that correspond to a listed service (e.g., electrical services, plumbing services, painting services, etc.). For example, intermediary exchange service may establish one or more hierarchical value release protocols for incrementally transferring value from a submitting member to a listing member. The hierarchical value release protocols, for example, may include a first release phase in which a listing provider is provided, through the intermediary exchange service, an initial, up-front portion of the submission value (e.g., to buy supplies for a service, etc.). In addition, or alternatively, the hierarchical value release protocols may include a second release phase in which a listing provider is provided, through the intermediary exchange service, a secondary, intermediate portion of the submission value (e.g., after a portion of the service is completed, etc.). In some examples, the hierarchical value release protocols may include a third release phase in which a listing provider is provided, through the intermediary exchange service, a final portion of the submission value after the service is approved by the submitting member.

In some embodiments, the cross-item incentive service enables members to collaborate with one another to cross-sell their items by providing item samples with an exchange for a related item. For example, when a submitting member purchases an item, the cross-item incentive service may identify one or more related items from a predefined list of item samples. In the event that the cross-item incentive service identifies a related item that achieves a similarity threshold, the cross-item incentive service may automatically deliver the related item to the submitting user. By way of example, cross-item incentive service may identify that a submitting member bought a grill and, responsive to the purchase, provide barbeque sauce from another listing user to the submitting user.

In some embodiments, the cross-platform service enables access to various social media platform to communicate items listings across a plurality of connected social media accounts. For example, when a listing member lists an item the cross-platform service may automatically post the data item one or more connected social media platforms.

In some embodiments, the value determination service provides access to a plurality of related item listings for a listing member to identity a comparable for a data item. For example, the value determination service may search one or more cross-platform ecosystem to aggregated item values for a data item. In this manner, the value determination service may provide a dynamic price setting feature to help listing members set market-based hidden and/or visible locking thresholds.

In some embodiments, the location tracking module 216 implements safe location tracking mechanisms that leverage location data from multiple devices to temporarily track and share, in real-time, locations of members involved in an exchange. The location tracking module 216 may implement one or more location tracking services, including security monitoring services and secure location selection services.

In some embodiments, the location tracking services enable temporary multi-device location sharing between previously unaffiliated devices and an intermediary platform. For example, at the point of purchase when a submission is accepted, the location tracking services may instantiate a communication channel between the listing member and the submitting member. The listing member and the submitting member may leverage the communication channel to establish an exchange location, date, and time.

On the exchange date, location tracking service may request temporary location data from a listing member computing device and a submitting member computing device. The temporary location data request may include a request for location data (e.g., global positioning system (GPS) data, internet protocol (IP) location-based data, etc.) within a time window encompassing the exchange time. The time window, for example, may be based on a distance between a listing member home location and/or a submitting member home location from the exchange location. In some examples, the time window may be different for each of the members of the exchange. For example, a first-time window may be based on the distance between the listing member home location and the exchange location, whereas a second time window may be based on the distance between the submitting member home location and the exchange location. In some examples, the temporary location data request may include a request to track the member's locations during the time window(s). In response to an approval, the member computing devices may record and transmit location data to the collaboration platform 102.

In some examples, the location tracking service may provide temporary access to the listing member's location data to the submitting member. In addition, or alternatively, the location tracking service may provide temporary access to the submitting member's location data to the listing member.

In some examples, the location tracking service records the location data from the listing and submitting member computing devices in a protected data store, such as an Amazon Web Services Bucket. In some examples, the location tracking service may monitor the location to detect one or more location anomalies.

A location anomaly, for example, may be based on one or more time thresholds at a particular location. For example, a location anomaly may be detected in the event that the listing member and/or the submitting member are located at the exchange location for a time period that exceeds the time threshold. In some examples, the time threshold may be set by the listing and/or submitting member in response to the temporary location data request.

In addition, or alternatively, a location anomaly may be detected based on a comparison between a listing member location and a submitting member location. For example, a location anomaly may be detected in the event that one member leaves an exchange location, while another member remains at the exchange location.

As another example, a location anomaly may be detected based on a comparison between a reception of user input and the location data. For instance, a location anomaly may be detected in the event that a member does not provide a specific user input (e.g., an indication of safety, etc.) within time threshold (e.g., 5 minutes, etc.) after reaching an exchange location.

In some examples, the location tracking service may provide one or more alerts in response to a location anomaly. For instance, the one or more alerts may be provided to a member computing device associated with the location data that triggers the detection of the location anomaly. In some examples, a member may respond to the alert to provide a reason for the location anomaly. In addition, or alternatively, one or more alerts may be provided to one or more third parties designated by a member. For instance, a member may be associated with one or more exchange-specific (e.g., set for a specific exchange) and/or exchange-agnostic (e.g., set for all exchanges) affiliated members and/or other third-party entities (e.g., local law enforcement, private security personnel, etc.) that are subject to receiving an alert in the event of a location anomaly.

In some embodiments, the location tracking service may monitor physiological data of a member against a set of stored ranges for the member. In some examples, one or more alerts may be provided in response to a comparison between the physiological data and the set of stored ranges for the member.

In some embodiments, the location tracking services enable secure location selection services that enable a search and selection of a predesignated safe exchange location (schools, churches, police departments, etc.). For example, responsive to the acceptance of a submission, the location tracking service may provide a location search tool for a submitting member. The location search tool may include a menu with an option for the member to enter an address or select from a list of predesignated safe exchange locations based on the listing and submitting members' locations. In some embodiments, the list of predesignated safe exchange locations may include one or more locations that (i) are located between the listing and submitting members' locations and (ii) achieve one or more safety thresholds. The safety thresholds, for example, may include a predesignated list of location types, such as schools, churches, police stations, post offices, and/or the like, that are associated with a low rate of criminal activity. In some examples, the safety thresholds may include maximal criminal history record for a location. In some examples, the safety thresholds may include a requirement for surveillance equipment. In some examples, the safety thresholds may include a requirement for locking mechanisms (e.g., lock boxes, etc.).

In some embodiments, the intelligent search module 218 implements one or more dynamic, real-time search features to enhance search results and alerts for members. The real-time search features, for example, may include a radius-based search and alerting service, artificially intelligent audio notifications, among others.

In some examples, the radius-based search and alerting service may provide a search interface for browsing members that enables them to perform location-based searching for specific items and/or item categories within a selected radius of the member's current and/or designated location. For example, the intelligent search module 218 may prompt a member to enter a distance-based search radius (e.g., 15 miles, 50 miles, etc.) and/or a timing-based search radius (e.g., 30 minutes, 45 minutes, etc.).

In some examples, the radius-based search and alerting service may receive location data from a member computing device and dynamically update search results based on the member's location. For example, if the member chooses to search for an item within a certain chosen radius and it is not available, the member may initiate, via the radius-based search and alerting service, a request to receive an alert if the queried item(s) become available within the desired search radius as the location of the member updates over time. For example, if member searches for a rookie baseball card within a 50-mile radius, and one is not available within that radius, the radius-based search and alerting service enables the member to re-search at a greater radius or request an alert when it comes within a 50-mile radius of current and/or home location of the member. In this manner, if a member is traveling, it is possible to receive an alert of an opportunity to buy an item based on their current location. Similarly, some embodiments track the location of items (e.g., via an associated listing member's location data, item location data from one or more RFID tags, user input to update the item's location, etc.) and provides an alert in the event that the item enters the designated search radius.

In some examples, the artificially intelligent audio notification service may enable communication with the collaboration platform 102 through audio commands provided by a smart device. For example, a search query may be provided through a verbal command, and, in response, search results may be provided through an auditory response (e.g., a listing of top X results, email, and/or display on proximate display device, etc.). Additionally, browsing member may query, through verbal communications, for media, such as songs, artists, and/or the like, and play a mix of platform music in a certain genre. In some examples, listing members may verbally request updates regarding their listed items for sale, such as have any bids been made, and if so, how many, have any bids been accepted or rejected, and/or the like.

In some embodiments, the rating module 220 enforces strategic rating protocols to improve member traceability within a digital environment. The rating module 220, for example, may include a mandatory rating service, a rating filtration service, and a rating publication service.

In some examples, the mandatory rating service may require a submitting member to rate a listing member before completing an exchange. For example, at the point of exchange when the listing and submitting members meet up to finalize the exchange, the submitting member may inspects the item. If the item is acceptable, the listing and submitting members may confirm the acceptance of the exchange through the collaboration platform 102 and the collaboration platform 102 may release funds to the listing member. In some examples, the mandatory rating service may prevent the release of funds until the listing member provides a rating for the submitting member and/or the submitting member provides a rating for the listing member. In some examples, the listing and/or submitting member may be locked from a member account until a rating is provided in response to a completed exchange.

In some examples, the rating filtration service may dynamically filter a plurality of ratings for a member to ensure up-to-date insights. For example, the rating filtration service may continuously rotate the plurality of ratings to the most recent 25 ratings. In this manner, ratings may be modified on a rotating basis from the last to the first up until 25 transactions. At this point once there are 25 ratings the next rating (#26 rating) bumps up to the latest rating and the bottom #25 rating is dropped off. Thus, keeping only 25 ratings total at one time on a listing member's profile. This promotes a listing member's ability to keep his rating up through more exchanges.

In some examples, the rating filtration service may also filter one or more ratings for a submitting member. For example, a member may include multiple sets of ratings. A first set may include a listing member rating set and a second set may include a submitting member rating set. In this manner, a member may be rated based on their capacity to list quality items and their capacity to purchase items from other listing members within the collaboration computing environment.

For example, a submitting member may be rated based on whether or not the member accepted the bid and/or bought an item. A listing member may view a submitting member's rating to gauge a member's reliability before accepting submission from the submitting member.

In some examples, rating module 220 may leverage submitting member ratings to determine whether to accept a given submitting member's submission or not. For example, the rating module 220 may prioritize submitting members based on their ratings, such that a higher rated submitting member may be rewarded a submission in place of a lower rated submitting member (e.g., if the submission is placed at the same time or within a time threshold). In addition, or alternatively, the rating module 220 may toggle one or more features of the collaboration platform 102 for members based on their member ratings.

In some examples, the rating filtration service may automatically update a listing member's status to reflect exchange activity (e.g., average rating, number of completed exchanges, number rejected exchanges, etc.). In some examples, each listing member may be associated with a homepage that allows browsing members to review an exchange history for the listing member, including one or more past exchanges.

In some embodiments, the bid tracking module 222 includes blockchain platform mechanisms to establish secure network exchanges through a combination of centralized and distributed devices. For example, the bid tracking module 222 may leverage blockchain and cryptographic functionality to track a multi-stage bidding process. For example, the collaboration platform 102 may integrate with one or more third-party exchange networks, such as Stripe, etc. In some examples, a listing member may mandate an active third-party exchange account for a data item. In such a case, a submitting member may be prevented from providing a submission for the data item unless the submitting member has a third-party exchange account logged with the collaboration platform 102.

In addition, or alternatively, the bid tracking module 222 may integrate a blockchain protocol for security purposes, for example providing proof of identity and other details (when, who, how and where) for members of the collaboration platform 102. The blockchain protocol may define one or more distributed ledger entry formats for recording activity on the collaboration platform 102. For example, a distributed ledger entry may record time-stamped entries for (i) a data item listing, (ii) one or more item submissions for the data item listing, (iii) an accepted item submission for the data item listing, (iv) an accepted exchange location, (v) member location data during a tracked exchange, and/or the like. For example, the bid tracking module 222 may interact with one or more of the bid module 214, location tracking module 216, intelligent search module 218, and/or rating module 220 to generate time-stamped ledger entries recording a data trail from the generation of a data item to a completed exchange. In some examples, a distributed ledger entry may be added to a platform distributed ledger in accordance with a voting mechanism corresponding to the platform distributed ledger. The bid tracking module 222 may generate and publish a distributed ledger entry to the platform distributed ledger for activity involving both physical and digital items (e.g., art, music, etc.). In this manner, the bid tracking module 222 may provide a traceable record to verify that a submitting member has title to an exchanged item.

In some embodiments, the bid tracking module 222 may perform one or more automated regulatory actions for a digital item corresponding to data item listing. For example, after the generation of a data item (e.g., by uploading media content, etc.) corresponding to a digital item, the bid tracking module 222 may query one or more regulatory databases, such as the Broadcast Music Incorporated (BMI), United States Patent and Trademark Office (USPTO), American Society of Composers, Authors and Publishers (ASCAP), Society of European Stage Authors and Composers (SESAC), Society of Composers, Authors and Music Publishers of Canada (SOCAN), and/or the like, to identify registered owner of the digital item. In the event that the registered owner is not the listing member, the bid tracking module 222 may prevent the publication of a data item listing for the digital item. In addition, or alternatively, in the event that a registered owner is not found for the data item, the bid tracking module 222 may prompt the listing member to register the data item.

Upon upload of an original work (e.g., one that is not yet registered), the bid tracking module 222 generates a watermarked digital item and the watermark is added, through a distributed ledger entry, to the platform distributed ledger to record the original owner (e.g., the listing member) of the digital item. In response to an approval from the listing member, the bid tracking module 222 may generate a registration application, using one or more data item attributes provided for the digital item, and automatically submit the registration application to a regulatory authority. In some examples, one or more registrations may be required before an exchange is approved for the digital item.

More particularly, as an augmentation to user offering a digital item for sale or after purchase of a custom digital item from a service provider, some embodiments may query a member with a prompt “do you want us to log this into blockchain for IP rights tracking and monitoring?”. If they say yes, a blockchain ledger may be updated with a copy of the digital watermark associated with the item as well other information, such as the name, address, date, IP addresses of the members to an exchange involving the digital item, etc. The home page or dashboard for the members may also reflect the fact that a blockchain ledger entry was created for the exchange and/or provide a verification copy of the ledger entry.

### IV. Example Member Computing Device

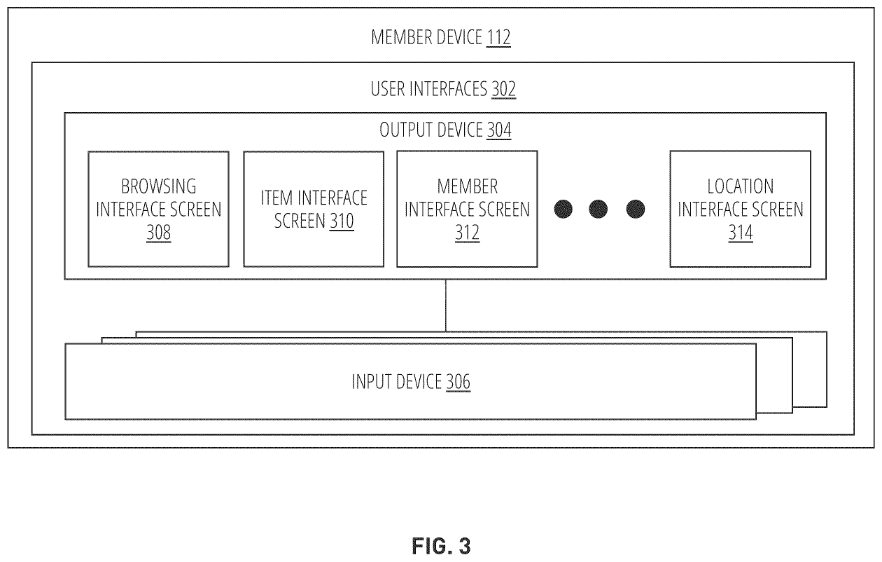

FIG. 3 provides a functional example of a member computing device 112 in accordance with some embodiments of the present disclosure. A member computing device 112 may be any computing device that is associated with one or more members of a collaborative computing system. By way of example, a member computing device 112 may include a desktop computer, mobile phone, tablet, phablet, notebook, laptop, and/or the like that is accessible to a particular member.

In some embodiments, a member computing device 112 includes a plurality of user interfaces 302. The user interfaces 302 may include one or more output devices 304 and/or input devices 306 that enable a member to interact with one or more portions of a collaborative computing environment. The output devices 304 and/or input device 306, for example, may include one or more integral components of the member computing device 112 and/or one or more peripheral devices communicatively coupled to the member computing device 112.

For example, the user interfaces 302 may include one or more output devices 304. The output devices 304 may include one or more displays, speakers, tactile instrument, and/or the like that are coupled to (e.g., via a wired, wireless, and/or bus connection, etc.) a processing element. For example, a user interface may be a user application, browser, and/or similar words used herein interchangeably executing on and/or accessible via the member computing device 112 to interact with and/or cause display of information/data from a collaboration computing system and/or one or more other computing entities described herein.

As another example, the user interfaces 302 may include one or more input devices 306. The input devices 306, for example, may include a keypad (hard or soft), a touch display, microphone, motion sensor, image sensor, and/or any other mechanism for recording input from a physical environment. In some embodiments including a keypad, the keypad may include (or cause display of) the conventional numeric (0-9) and related keys ( #, *), and other keys used for operating the member computing device 112 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

In some embodiments, the output devices 304 are configured to provide a sequence of interface screens for facilitating access to and collaboration with a collaborative computing environment. One or more of the interface screens, for example, may include a browsing interface screen 308, an item interface screen 310, a member interface screen 312, a location interface screen 314, and/or the like.

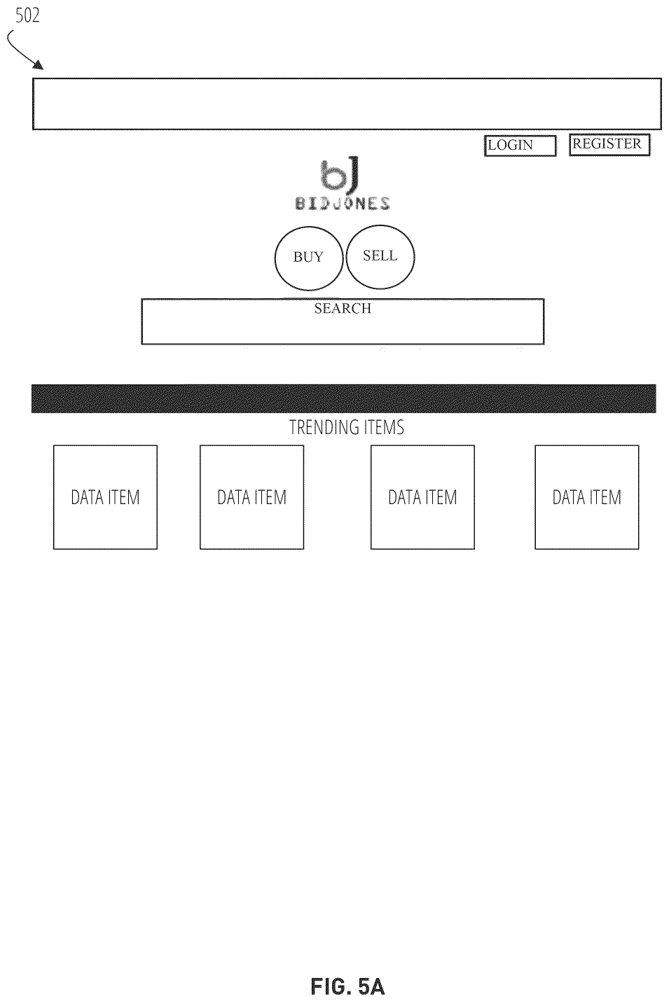

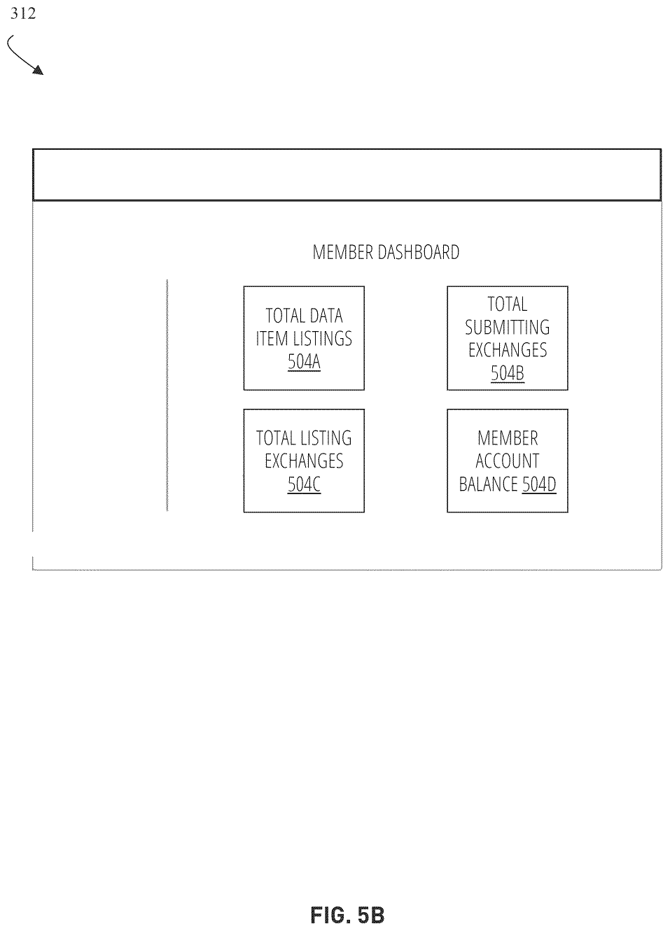

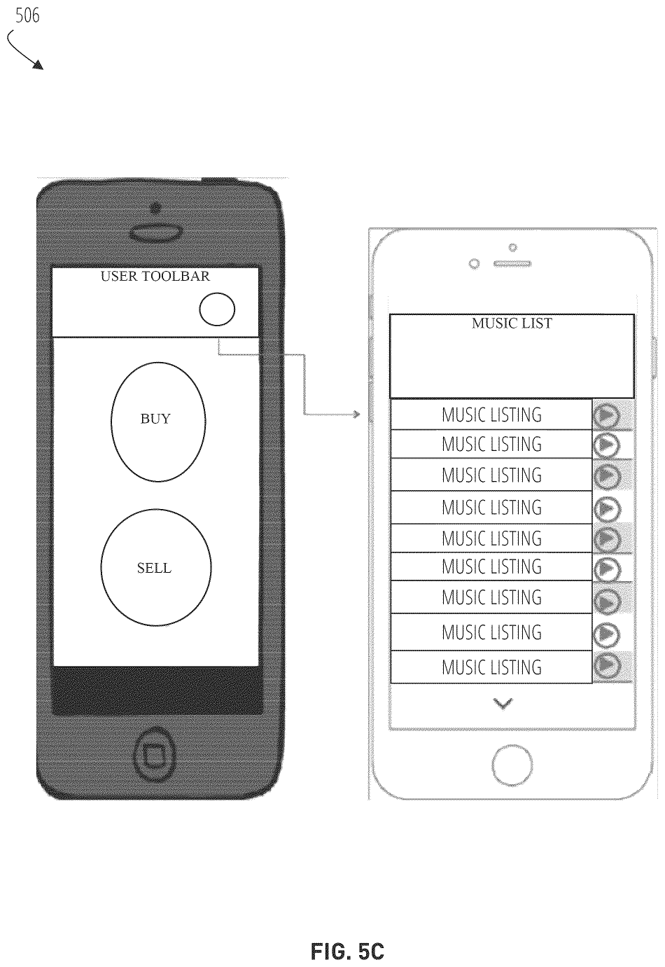

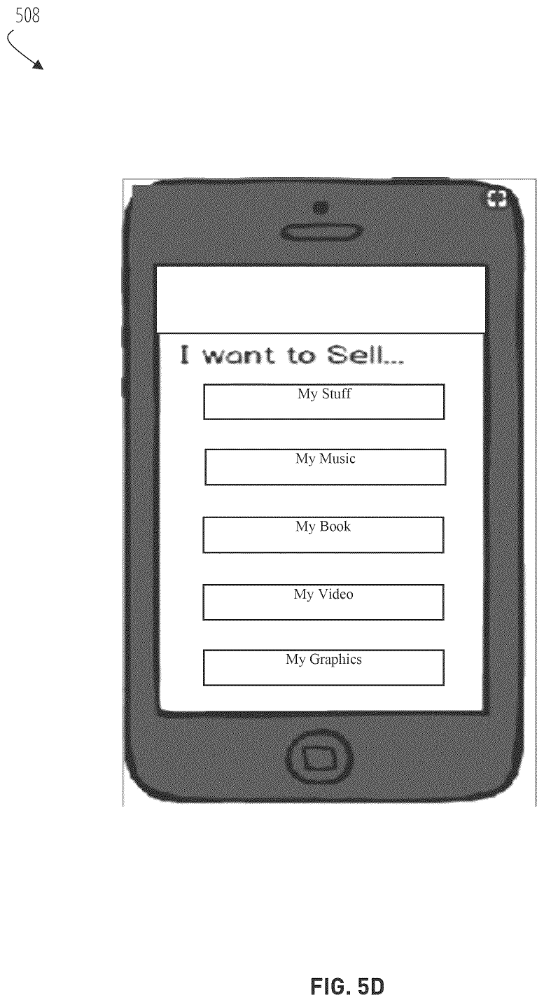

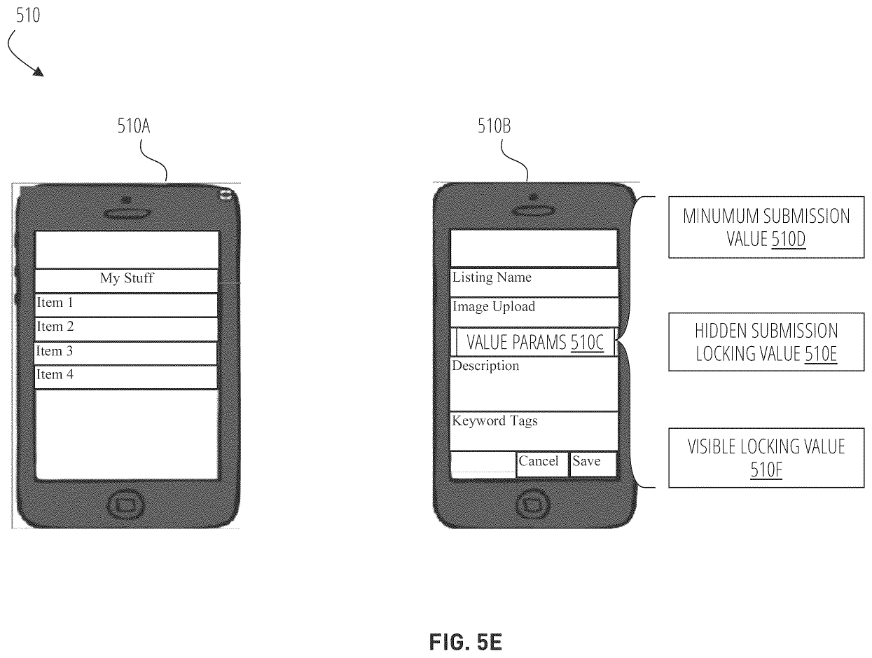

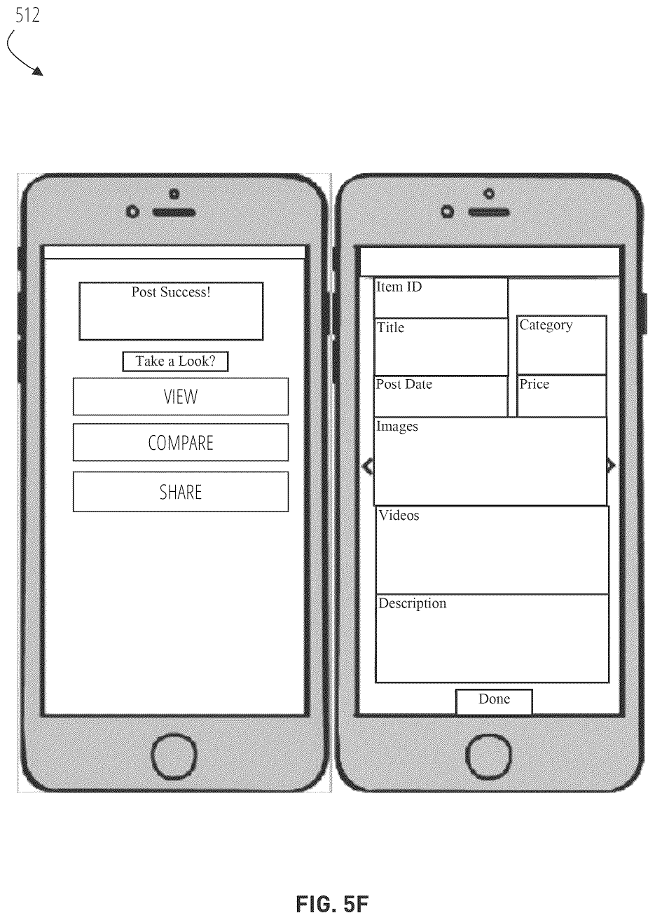

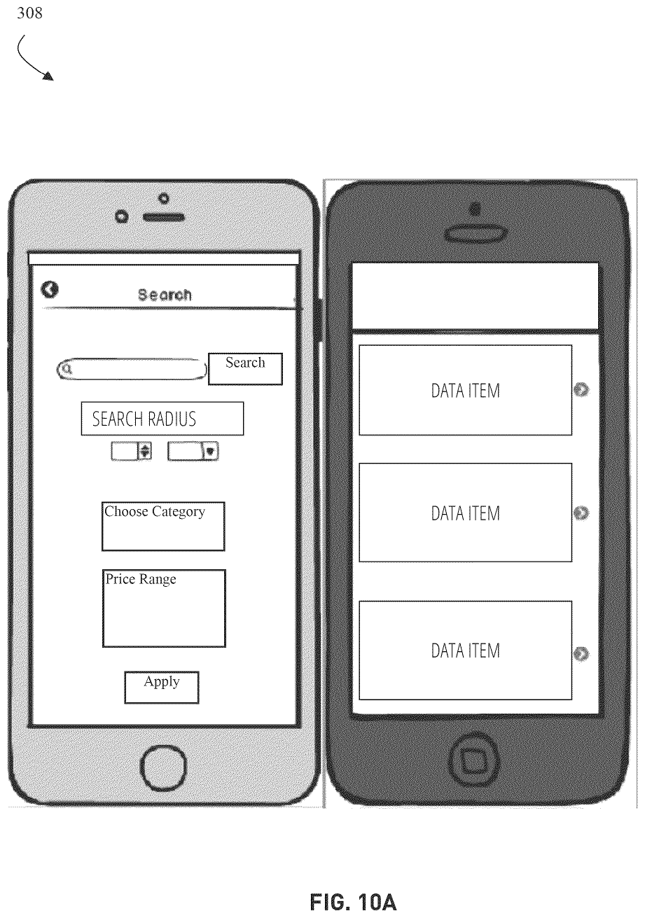

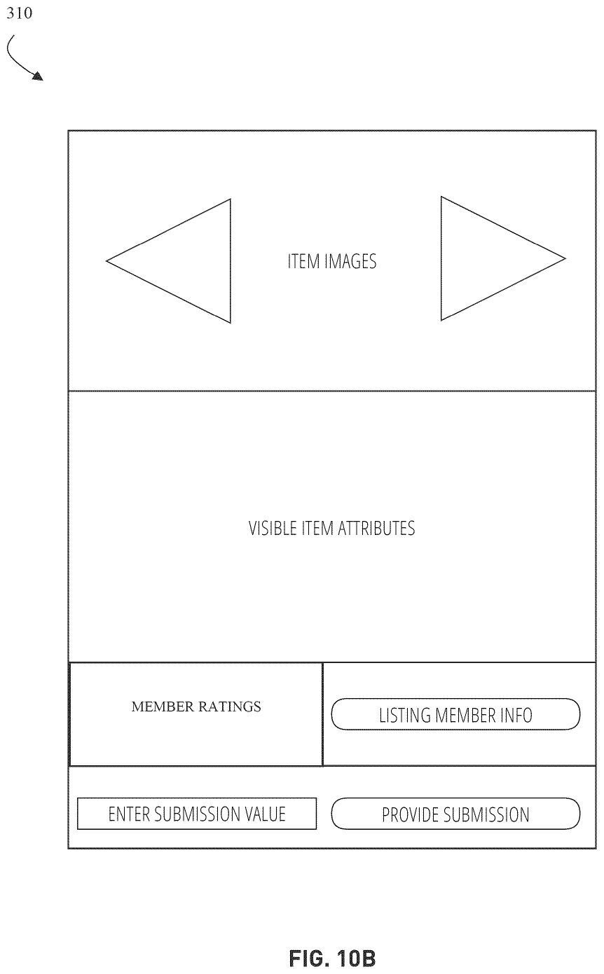

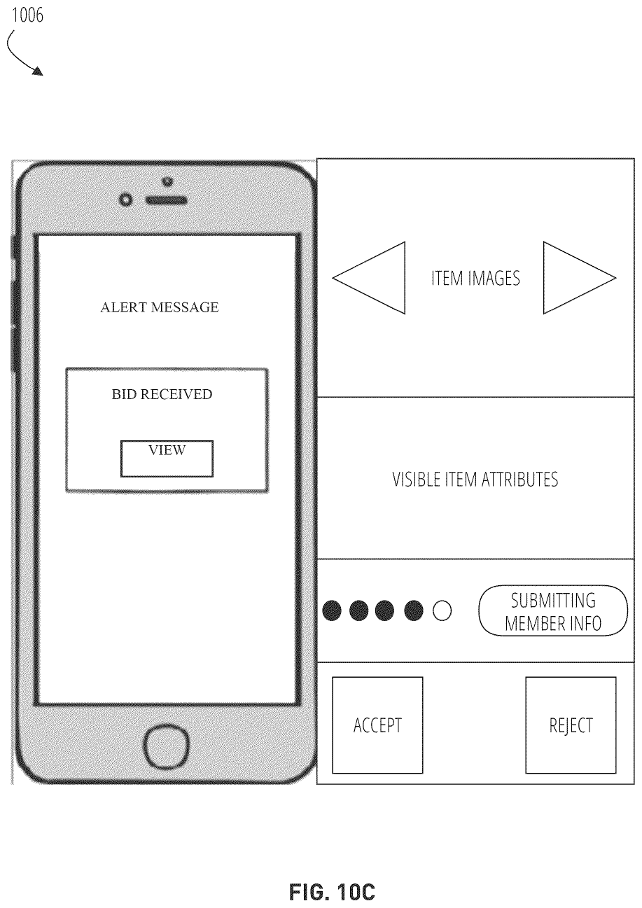

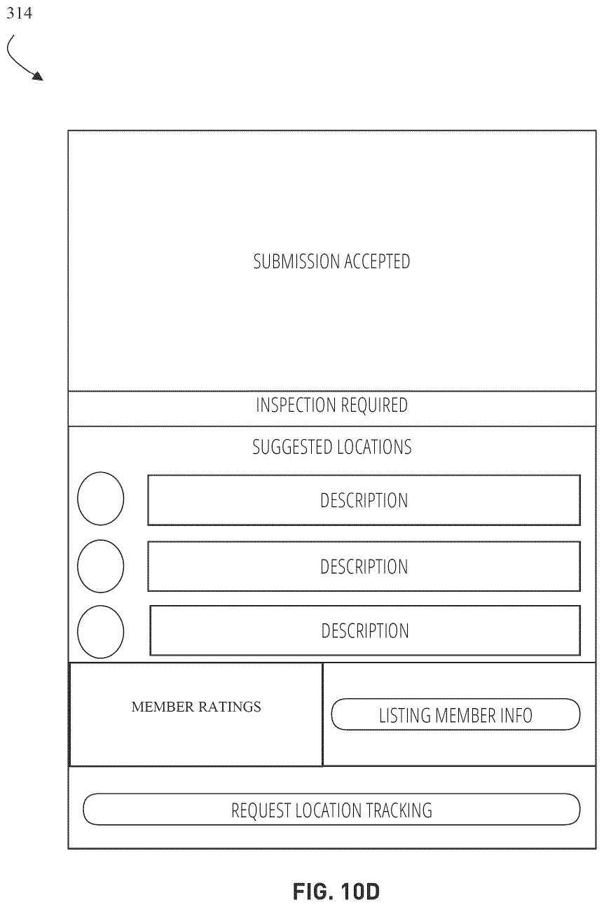

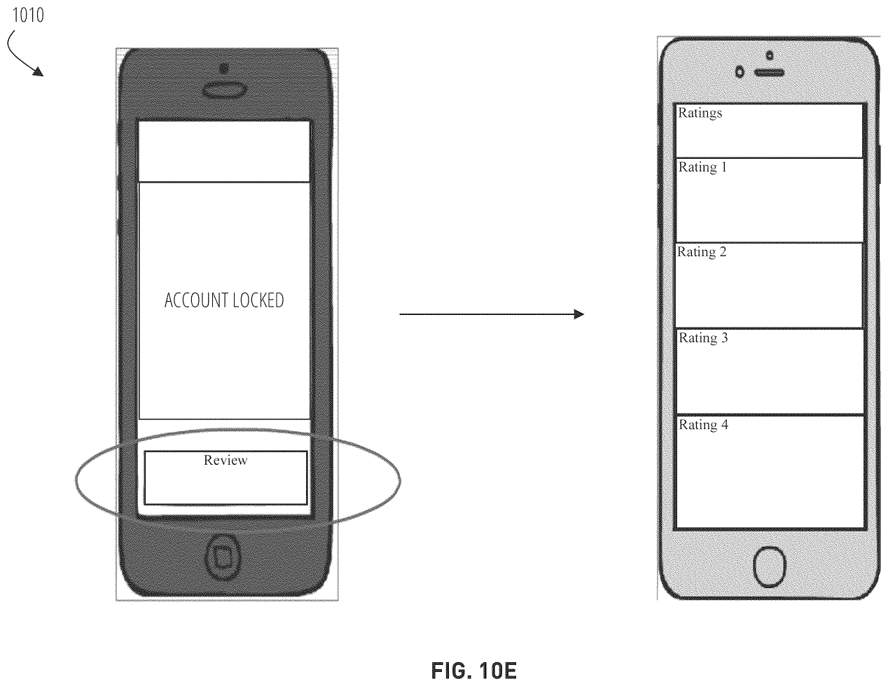

In some embodiments, the browsing interface screen 308 includes a plurality of interactive icons for performing location-based searching, as described in further detail with reference to FIG. 10A. In some embodiments, the item interface screen 310 incudes a plurality of interactive icons for interacting with a data item, as described in further detail with reference to FIG. 10B. In some embodiments, the member interface screen 312 includes a plurality of interactive icons for interacting as a member of the collaboration platform, as described in further detail with reference to FIG. 5B. In some embodiments, the location interface screen 314 includes a managing a physical touchpoint of an exchange made within the collaboration platform.

### V. Overview

Various embodiments of the present disclosure make important technical contributions to traditional, Internet-based collaboration technologies. Specifically, the embodiments of the present disclosure provide device networking techniques and computing services for creating and facilitating a distributed ecosystem of devices that may collectively engage in a secure, unbiased, and safe peer-to-peer marketplace. The networking techniques and computing services may be established by a centralized collaboration platform that may enforce one or more networking protocols to control interactions between a plurality of distributed devices within the computing ecosystem. The networking protocols, for example, may be tailored to de-biasing, securing, and ensuring safety with respect to digital and physical interactions facilitated by the computing ecosystem by addressing traditional technical challenges specific to an Internet-based environment. For example, the networking protocols may be enforced by different computing services that are each tailored to technical challenges with respect to user anonymity, ephemeral digital interactions, and inherent bias towards controlling parties.

To do so, some of the embodiments of the present disclosure include locking mechanisms that are tied to a fair, unbiased value of an item listing within a digital environment. The locking mechanism may include a hidden locking threshold that may redefine the controlling parties to a digital interaction. The hidden locking threshold may enable a submitting party to automatically lock a data item by submitting a value within a fair market value of the data item. By hiding the locking threshold, the collaboration platform may enforce fair and safe interactions without precluding digital features that are inherent to a traditional online marketplace, such as buy-it-now features that allow a user to skip a bidding process. In this way, the locking mechanism of the present disclosure presents a solution to a problem that is specific to the Internet (e.g., how to accommodate fair digital interactions without sacrificing the utility of traditional online bidding features).

As another example, some of the embodiments of the present disclosure include temporary location sharing techniques that improve user safety within the physical world without sacrificing the anonymity provided by a digital environment. In this regard, the collaboration platform may provide location selection, tracking, alerting techniques to improve the selection of safe physical exchange locations between two unaffiliated members of a digital environment. At times, the safe physical exchange locations may be associated with connected safety devices, such as emergency towers, that may be dynamically triggered to ensure safety during a physical exchange. In some examples, the collaboration platform may temporarily track to location of two users associated with an exchange to monitor a current location of the users and, if needed, trigger a safety response by interacting with one or more devices, such as the connected safety devices at a particular location.

Moreover, the collaboration platform may improve upon traditional location sharing techniques by acting as an intermediate interface between two unaffiliated devices. In this manner, the collaboration platform may control the line of communication between two users. This, in turn, allows for truly temporary location sharing without exposure to user credentials and/or private information, such as phone numbers, home addresses, and/or the like. For example, the temporary location sharing techniques may share filtered location data across two unaffiliated devices based on a proximity to a selected exchange location. The filtered location data may be transmitted after each device is a particular distance from a home address and may filter personal data from the location data, such as underlying metadata that may identify private user information. This, in turn, improves upon traditional location sharing techniques that expose the personal data of participating users. By improving the security of such techniques, some embodiments of the present disclosure enable location sharing between unaffiliated users that, when integrated to a digital environment, may improve digital interactions between users within the digital environment. In this way, some embodiments of the present disclosure provide a hybrid collaboration platform that may combine the benefits of physical interactions (e.g., physical inspections, etc.) with those provided by a digital marketplace (e.g., anonymity, reach, etc.).

As yet another example, some embodiments of the present disclosure include integrated blockchain services to address the ephemeral nature of digital interactions. For example, some embodiments of the present disclosure, may implement a distributed ledger tracking system for automatically tracking exchanges and/or any other interactions within a digital environment. In this manner, blockchain technology may by incorporated to a digital ecosystem to create a verifiable record of interactions between users within the digital ecosystem. By doing so, the ephemeral nature of digital interactions may be addressed by automatically recording the ownership of data items exchanged within the digital ecosystem in response to verified user interactions. These same blockchain mechanisms may record other interactions within the digital ecosystem, including user ratings, user locations within a proximity of a physical exchange location, and/or any other data that may be relevant to veracity or legality of an exchange.

In some examples, the recorded data may be tailored to regulations within a regulatory state to automatically create verifiable records of exchange that satisfy legal requirements of a physical location associated with the exchange. In this manner, the hybrid collaboration platform of the present disclosure may integrate constraints of a physical environment to a digital ecosystem to avail a user to the benefits of the digital ecosystem while complying with various physical constraints that may govern an exchange. This, in turn, allows for complex exchanges (e.g., expensive purchases, such as housing, vehicles, etc.) that are traditionally confined to a physical marketplace.

### VI. Example Item Generation Operations

Various embodiments of the present disclosure make important technical contributions to traditional peer-to-peer ecosystems. In particular, systems and methods are disclosed herein that implement a collaboration platform with functionalities configured to remove bias, enhance safety, and enforce reliability, among other measures to improve traditional e-commerce ecosystems. By doing so, some embodiments of the present disclosure address significant technical challenges inherent to e-commerce systems.

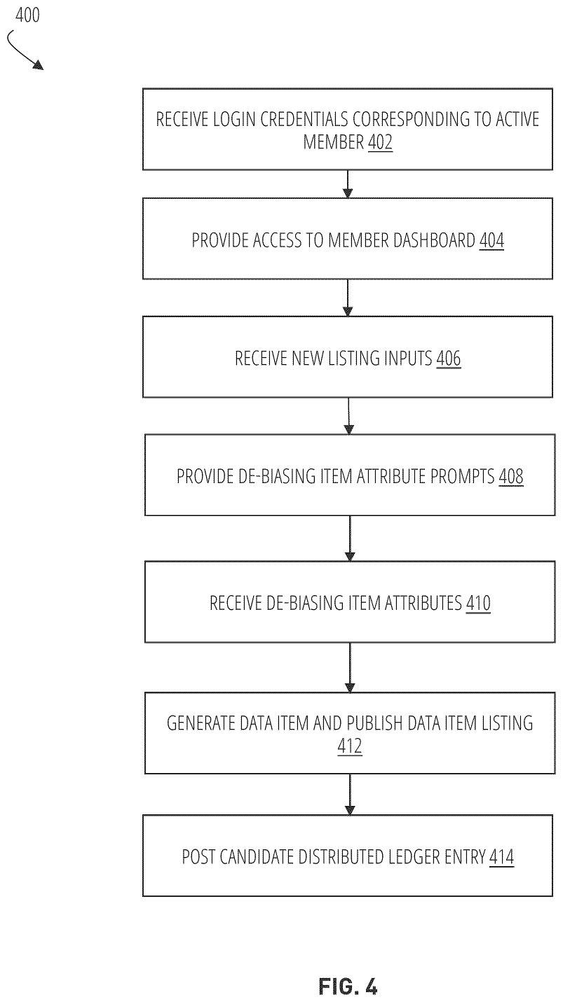

FIG. 4 is a flowchart diagram of an example process 400 for generating a de-biased data item listing in accordance with some embodiments discussed herein. The flowchart depicts an item listing process 400 for improving the de-biasing item within a collaborative computing environment. The process 400 may be implemented by one or more computing devices, entities, and/or systems described herein. For example, via the various steps/operations of the process 400, the collaboration platform 102 may leverage improved user interfaces and data management techniques to generate de-biased data items. By doing so, the process 400 enables the generation of data items that rebalance the control within an electronic peer-to-peer marketplace between listing and submitting members.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, the process 400 includes, at step/operation 402, receiving login credentials corresponding to an active member. For example, the collaboration platform 102 may receive a username and credential for a recorded member of the collaboration platform 102. The username and credential may be provided via a login screen displayed by a member computing device. An example login screen is provided with reference to FIG. 5A.

In some embodiments, the process 400 includes, at step/operation 404, providing access to a member interface. For example, the collaboration platform 102 may provide access to the member interface in response to validation of the username and credential for the member. In some examples, the collaboration platform 102 may initiate a display of a member interface screen to a member through the member computing device. An example member interface screen is provided with reference to FIG. 5B.

In some embodiments, the process 400 includes, at step/operation 406, receiving a new listing input from the member. For example, the collaboration platform 102 may receive a new listing input via one or more sequences of user interactions with a member computing device. The new listing input, for example, may be provided via one or more new listing screens, examples of which are provided with reference to FIGS. 5C-D.

Turning back to FIG. 4, in some embodiments, the process 400 includes, at step/operation 408, providing one or more de-biasing attribute prompts to the member. For example, responsive to a new listing input, the collaboration platform 102 may provide one or more de-biasing attribute prompts for configuring a data item. In some examples, the one or more de-biasing attribute prompts may be provided through a new listing configuration screen displayed by a listing member computing device. Example new listing configuration screens are shown with reference to FIG. 5E.

In some embodiments, the process 400 includes, at step/operation 410, receiving de-biasing item attributes. For example, the collaboration platform 102 may receive one or more user input that identify one or more de-biasing attributes for a data item. The de-biasing attributes, for example, may be responsive to the one or more de-biasing attribute prompts.

In some embodiments, the process 400 includes, at step/operation 412, generating a data item and publishing a data item listing. For example, the collaboration platform 102 may generate a data item based on the one or more de-biasing attributes. The collaboration platform 102 may publish the data item listing based on the newly generated data item. In some examples, the data item listing may be provided for display via one or more browsing and/or item selection interface screens. In some examples, the data item listing may be configured to receive one or more submissions and, in response to a submission achieving a locking threshold, the data item listing may be locked. In some examples, the interface screens may be provided within a region of a website page and/or user interface of an application for a smart phone, tablet, and/or any other member device.

In some examples, the one or more interface screens may include a visible locking threshold (e.g., a buy-it-now price) that indicates a locking value and upon user selection of the locking threshold automatically initiates an electronic transaction to complete a sale of an item. In some examples, the one or more interface screens may include a locking indicator that visually indicates that a data item is associated with the locking threshold without identifying a hidden submission locking value of the locking threshold.

In some examples, the data item listing may be provided to the listing member through a confirmatory data item screen displayed by the listing member computing device. Example confirmatory data item screens are shown with reference to FIG. 5F.

In some embodiments, the process 400 includes, at step/operation 414, posting a candidate distributed ledger entry in response to a new data item listing. For example, the collaboration platform 102 may post the candidate distributed ledger entry for augmenting a distributed ledger maintained by the collaboration platform 102 and/or one or more affiliated computing devices, such as a plurality of member computing devices, opted-in member computing devices, and/or the like.

In some embodiments, at step/operation 414, the collaboration platform 102 generates a candidate distributed ledger entry indicative of activity within the collaborative computing environment. In the event of a new data item listing, the candidate distributed ledger entry may include the data item (and/or one or more visible/hidden attributes thereof), a listing member associated with the data item, a time stamp corresponding to the data item listing, and/or the like. In some examples, in the event that the data item corresponds to a digital item, the candidate distributed ledger entry may include a digital watermark for the digital item. In some examples, the candidate distributed ledger entry may include an IP address corresponding to a listing user at the time the data item in listed.

In some embodiments, the collaboration platform 102 may provide the candidate distributed ledger entry to one or more distributed computing devices. The candidate distributed ledger entry may be added to a platform distributed ledger in accordance with a voting mechanism corresponding to the platform distributed ledger.

Some techniques of the present disclosure enable the generation of action outputs that may be performed to initiate one or more real world actions to achieve real-world effects. The de-biasing techniques of the present disclosure, for example, may be used, applied, and/or otherwise leveraged to generate data listings for real-world and/or physical items. These listings may be communicated across a plurality of a devices within a collaboration computing environment and allow real-time interaction between the devices. In some examples, in response to a selection of a data listing, a physical item corresponding to the data listing may be automatically packaged and shipped to a submitting member. By way of example, the collaboration platform 102 may provide one or more control instructions to trigger a robotic packaging system to perform one or more packaging operations. The robotic packaging system may execute the control instructions to physically place an item into a packaging material (e.g., a box, envelope, etc.), label the packaging material, and ship the packaged item to the submitting user.

Other actions may include the initiation of automated instructions across and between devices, automated notifications, automated scheduling operations, automated precautionary actions, automated security actions, automated data processing actions, and/or the like. By way of example, the collaboration platform 102 may facilitate real-time alerting actions for a listing member to continuously update the listing member with respect to data listing.

### VII. Example Item Generation User Interfaces

The user interface screens illustrated in FIGS. 5A-F are provided to facilitate de-biased data item listings from multiple member computing devices individually operating within a digital ecosystem. The user interface screens are provided as just one set of examples. In some examples, a member computing device is configured to generate and/or select user interface screens based on a user input provided throughout a data item listing process. In addition, or alternatively, a member computing device may be configured to access one or more user interface screens hosted by the collaboration computing system. In such a case, the collaboration computing system may receive a request (e.g., one or more API calls, etc.) from the member computing device and grant access to data representative of a particular user interface screen in response to the request.

The user interface screens provided by FIGS. 5A-F may be rearranged and/or branch out from each other to form a plurality of exchange flow processes in which each user interface screen may depend on user input provided in a preceding user interface screen. At each user interface screen, data may be displayed for facilitate a de-biased data item listing. Thus, each user interface screen and/or the order in which each user interface screen is displayed may be based on a de-biased data item listing process.

FIG. 5A specifically illustrates an example login screen 502 for a collaborative computing environment. The login screen 502, for example, may include a platform banner and one or more interactive icons. The interactive icons may include one or more log-in and/or register options and/or one or more action options for browsing and/or listing a data item without registering with the collaborative computing environment. In some examples, the interactive icons may include one or more trending data item icons that may redirect a member to a data item listing screen for a corresponding data item.

FIG. 5B specifically illustrates an example member interface screen 312 for a member of the collaborative computing environment. The member interface screen 312 may include one or more member attributes for the member, such as total data item listings 504A, total submitting exchanges 504B, total listing exchanges 504C, and/or member account balances 504D.

FIG. 5C specifically illustrates an example member action screen 506 for a member of the collaborative computing environment. The mem ber action screen 506 may include one or more interactive icons that allow a member to either browse one or more posted data item listings and/or post a new data item listing. In some examples, the one or more interaction icons may include ambiance icons that allow a member to select background media content while performing an action within the collaborative computing environment. For example, the member may select a song from a list of available music. In some examples, the music may include one or more songs associated with other data item listings (e.g., available for purchase) within the collaborative computing environment. In this manner, the collaboration platform may allow continuous sampling of media-related data items while members interact within a collaborative environment.

FIG. 5D specifically illustrates an example new listing screen 508. The new listing screen 508 may include a plurality of interactive icons for selecting item type and initiating a new listing configuration. The item types, for example, may include prelisted items (e.g., “my stuff”), music (e.g., “my music”), books (e.g., “my books”), videos (e.g., “my videos”), graphics (e.g., “my graphics), and/or the like. A selection of one of the interactive icons may transition a member to a new listing configuration screen that is tailored to a particular item type.

FIG. 5E specifically illustrates example new listing configuration screens 510. The new listing configuration screens 510, for example, may include a relisting screen 510A and/or a new listing screen 510B. The new listing screen 510B may include a plurality of de-biasing prompts for entering visible and/or hidden item attributes for the data item. The di-biasing prompts, for example, may include prompts to enter one or more value parameters 510C for a data item. The value parameters 510C, for example, may include a minimum submission value 510D, a hidden submission value 510E, and/or a visible locking value 510F.

FIG. 5F specifically illustrates example confirmatory data item screens 512. The confirmatory data item screens 512, for example, may include a data item creation confirmation screen and/or a pre-publication screen. The data item creation confirmation screen may include an alert indicative of completion of a data item listing. The alert may include one or more interactive icons for viewing the data item listing, comparing the data item listing to related listings, and/or sharing the data item listing to one or more specific members of the collaborative computing environment and/or to one or more third-party users through one or more connected social media platforms.

### VIII. Example Exchange Facilitation Operations

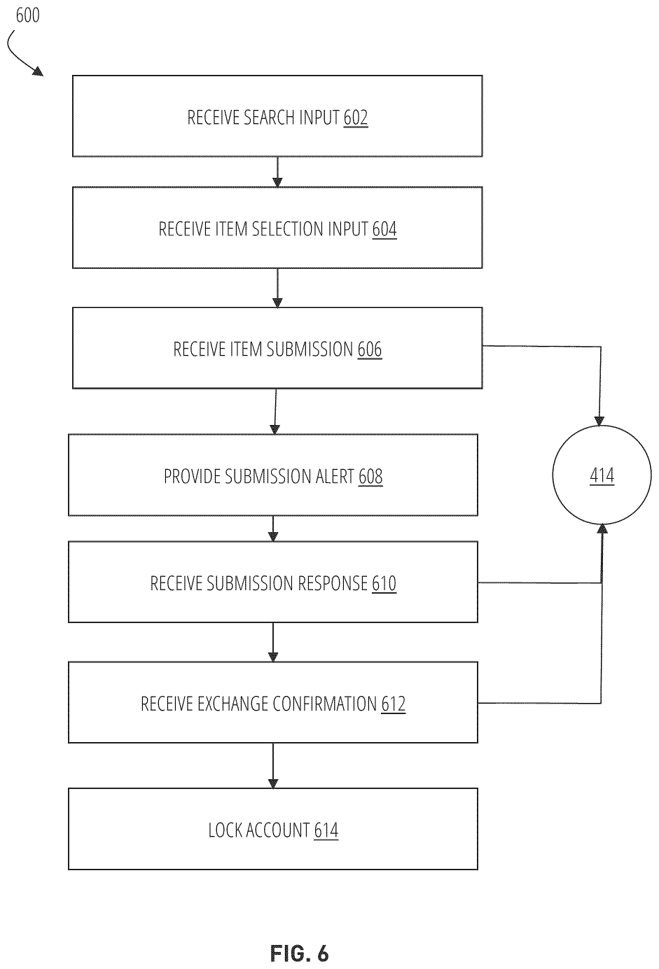

FIG. 6 is a flowchart diagram of an example process 600 for facilitating a secure exchange in accordance with some embodiments discussed herein. The flowchart depicts a multi-stage exchange process 600 for reducing bias and improving security and reliability within a peer-to-peer marketplace. The process 600 may be implemented by one or more computing devices, entities, and/or systems described herein. For example, via the various steps/operations of the process 600, the collaboration platform 102 may leverage various computing functionalities to enhance a collaborative computing environment. By doing so, the process 600 enables the improved peer-to-peer digital collaboration techniques that directly address technical challenges within the field of e-commerce.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving a search input. For example, the collaboration platform 102 may provide, via a member computing device, a browsing interface screen. The collaboration platform 102 may receive the search input through user input to the browsing interface screen. An example browsing interface screen is provided with reference to FIG. 10A.

In some embodiments, the process 600 includes, at step/operation 604, receiving an item selection input. For example, responsive to the search input, the collaboration platform 102 may provide, via a member computing device, a browsing interface screen. The collaboration platform 102 may receive the item selection input through user input to the browsing interface screen. For example, the collaboration platform 102 may receive, through the browsing interface screen, an item selection input that corresponds to a data item. The data item may be previously generated in accordance with one or more techniques of the present disclosure, such as those described with reference to FIG. 4.

In some examples, the data item may include a data record that includes one or more visible attributes and/or one or more hidden attributes corresponding to a physical and/or digital item or service. By way of example, a data item may include one or more item attributes that correspond to a physical item (e.g., clothes, furniture, electronic devices, etc.), a digital and/or physical book, a media item, such as a video (e.g., movie, etc.) or audio file (e.g., song, etc.), a graphic, and/or the like.

The one or more visible attributes may include one or more images, samples, item descriptions, item dimensions, listing member attributes, and/or the like. In some examples, the one or more visible attributes may include a member rating identifier for a listing member corresponding to the data item. In some examples, the one or more visible attributes may include an item status that identifies an interactivity the data item. An item status for the data item, for example, may reflect an available, pending, locked, and/or unavailable status for the data item. An available status, for example, may be reflective of a data item that may accept item submissions. A pending status may reflect that one or more item submissions have been provided for the data item. A locked status may reflect that an item submission has achieved a locking threshold associated with a data item and, responsive to the item submission, additional item submissions are no longer acceptable. An unavailable status may reflect that an exchange has been completed for the data item. As described herein, the one or more visible attributes may be accessible to a browsing member through an item interface screen.

In some examples, the one or more hidden attributes may include one or more internal control settings, set by a listing member, to control a distribution of the data item. For example, the one or more hidden attributes may include one or more hidden value parameters for accepting an item submission that are intentionally hidden from browsing member. The one or more hidden attributes, for example, may not be accessible to a browsing member through an item interface screen.

By way of example, a data item may be associated with one or more value parameters. A first set of the value parameters may be visible attributes that are accessible to a user, whereas a second set of the value parameters may be hidden attributes that are not accessible to a user. The one or more visible attributes, for example, may include a minimum submission value that identifies a minimum bid amount (and/or bid increase from a current bid amount) for providing item submission for the data item. Other visible attributes may include a current submission value that identifies a current bid amount for the data item and a visible locking submission value that identified a maximum value for ending the bidding process (e.g., a buy-it-now option). In some examples, the one or more hidden attributes may include a hidden submission locking value that is between the minimum submission value and the visible locking submission value. The hidden submission locking value, for example, may identify a hidden locking threshold for the data item. In some examples, the one or more visible attributes may include a locking indicator attribute corresponding to the locking threshold and visually indicating that the data item is associated with the locking threshold without identifying the hidden submission locking value of the locking threshold. In this way, a browsing member may participate in a bidding process with an understanding that the bidding process will be locked based on a hidden value. In some examples, the hidden submission locking value may correlate to a fair market value to remove bias from the bidding process and protect a submitting member.

In some embodiments, the process 600 includes, at step/operation 606, receiving an item submission. For example, responsive to the item selection input, the collaboration platform 102 may provide for display, through an item interface screen displayed by a member computing device, one or more visible attributes for the data item. An example item interface screen is provided with reference to FIG. 10B.

The collaboration platform 102 may receive, through the item interface screen, an item submission input that identifies a submitted value for the data item. In some examples, the item interface screen may include an interactive submission icon and the item submission input may be provided through an interactive submission icon of the item interface screen.

In some embodiments, responsive to the item submission input, the collaboration platform 102 may generate a candidate distributed ledger entry indicative of the item submission input and/or one or more characteristics thereof (e.g., a time, a submitting member, a submitted value, etc.) and provide the candidate distributed ledger entry to one or more distributed devices, as described herein with reference to step/operation 414 of FIG. 4.

In some embodiments, the process 600 includes, at step/operation 608, providing a submission alert. For example, the collaboration platform 102 may provide the submission alert to a listing member computing device corresponding to a listing member associated with the data item. In some examples, the submission alert may be provided in the event that the submitting value does not achieve a submission locking value (e.g., a hidden/visible). An example submission alert is provided with reference to FIG. 10C.

In some embodiments, the process 600 includes, at step/operation 610, receiving a submission response. For example, the collaboration platform 102 may receive the submission response from the listing member computing device. The submission response, for example, may include an acceptance, rejection, and/or hold for an item submission. In some examples, the submission response is providing the collaboration platform 102 in response to a user selection through a submission alert screen.

In some embodiments, responsive to the submission response, the collaboration platform 102 may generate a candidate distributed ledger entry indicative of the submission response and/or one or more characteristics thereof (e.g., a time, a corresponding item submission input, a submitting member, a listing member, a submitted value, an acceptance/rejection/hold, etc.) and provide the candidate distributed ledger entry to one or more distributed devices, as described herein with reference to step/operation 414 of FIG. 4.

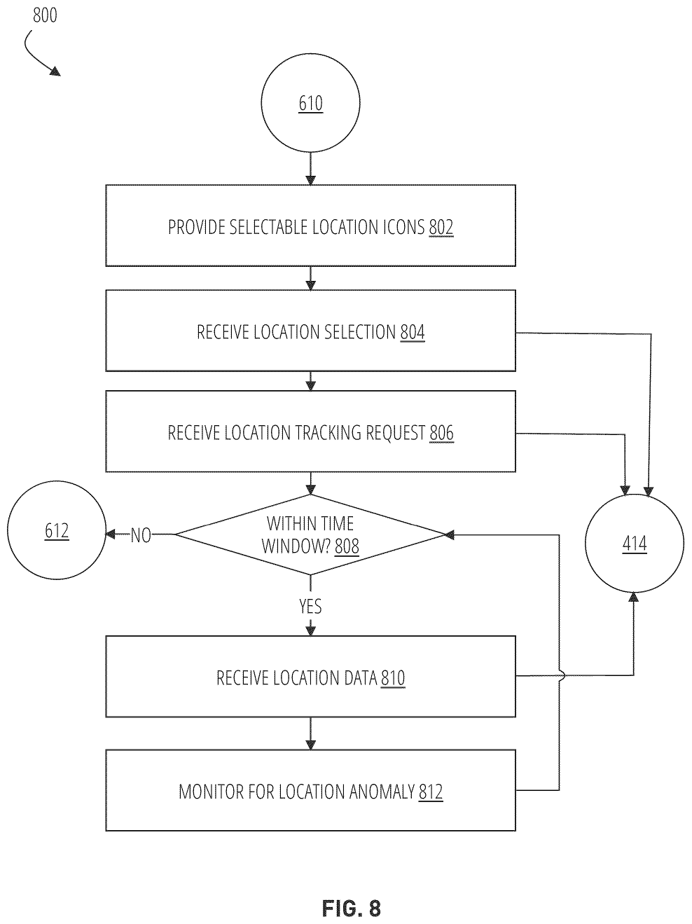

In some embodiments, the process 600 includes, at step/operation 612, receiving an exchange confirmation. For example, the collaboration platform 102 may receive an exchange confirmation from the listing member computing device, the submitting member computing device, and/or both. The submission exchange confirmation may identify a completion of an exchange of value for the item corresponding the to the data item. The exchange confirmation, for example, may include a confirmation of the performance of an inspection of the item, as described in further detail herein with reference to FIG. 8.

In some embodiments, the collaboration platform 102 initiates an exchange in a multi-stage process. For instance, the collaboration platform 102 may perform an initial transaction operation to (i) deduct the submitted value from a submitting account associated with a submitting member and (ii) store the submitted value in an intermediary account. After receiving a completed transaction input from the submitting member, the collaboration platform 102, may perform a secondary transaction operation to (i) deduct the submitted value from the intermediary account and (ii) provide the submitted value to a listing account associated with a listing member. In some examples, the completed transaction input may be responsive to a verified physical inspection of a physical item corresponding to the data item. In such a case, the funds for an exchange may be securely stored in escrow until an item verified as conforming with one or more inspection standards.

In some embodiments, responsive to the exchange confirmation, the collaboration platform 102 may generate a candidate distributed ledger entry indicative of the item submission input and/or one or more characteristics thereof (e.g., a time, a submitting member, a submitted value, etc.) and provide the candidate distributed ledger entry to one or more distributed devices, as described herein with reference to step/operation 414 of FIG. 4. The candidate distributed ledger entry, for example, may include the data item (and/or one or more visible/hidden attributes thereof), the listing member associated with the data item, the item submission input, and the submitting user associated with the item submission input. In some examples, the candidate distributed ledger entry include a plurality of IP addresses respectively corresponding to the listing user, the submitting user, and/or a third-party computing entity (e.g., a computing entity that facilitates a download of a digital item, etc.).

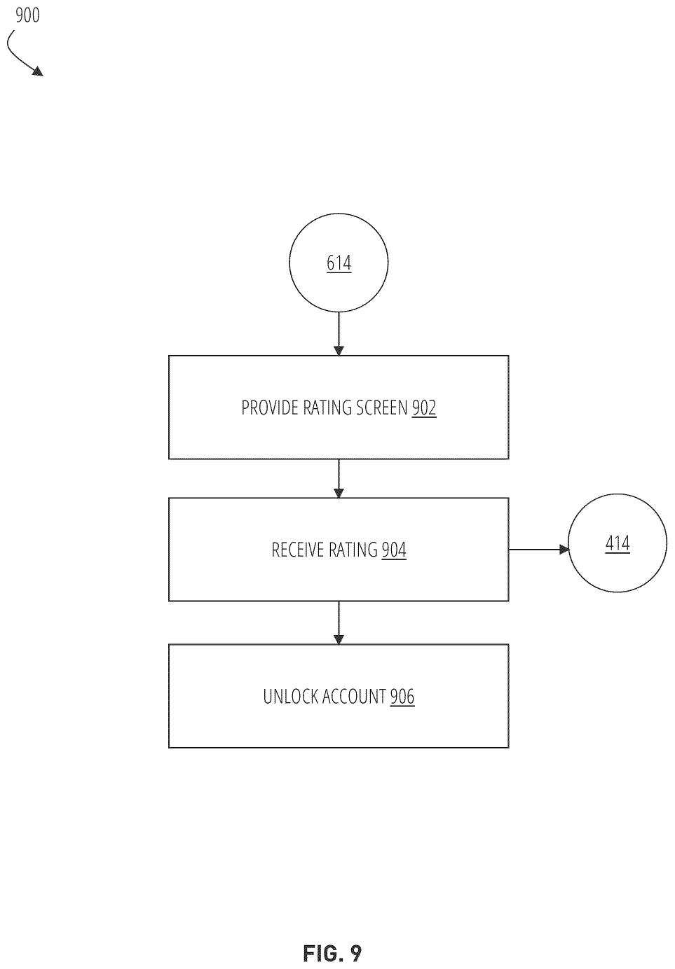

In some embodiments, the process 600 includes, at step/operation 614, locking an account of the listing and/or submitting member associated with the exchange. For example, the collaboration platform 102 may lock the account of the listing and/or submitting member to improve collaboration in a ranking scheme, as described with reference to FIG. 9.

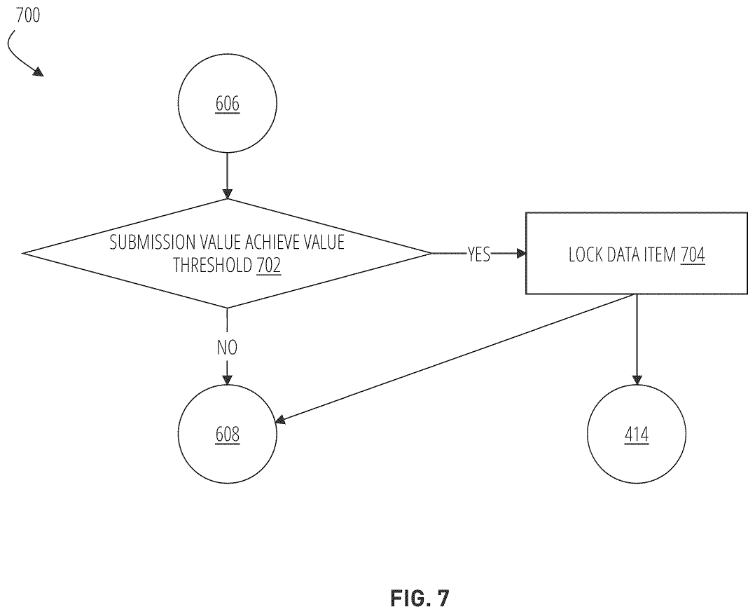

FIG. 7 is a flowchart diagram of an example process 700 for removing bias from a peer-to-peer digital marketplace in accordance with some embodiments discussed herein. The flowchart depicts an exchange process 700 for reducing bias using a hidden, fair market value, submission locking mechanism. The process 700 may be implemented by one or more computing devices, entities, and/or systems described herein. For example, via the various steps/operations of the process 700, the collaboration platform 102 may leverage various computing functionalities to enhance a collaborative computing environment. By doing so, the process 700 enables the improved peer-to-peer digital collaboration techniques that directly address technical challenges within the field of e-commerce.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

The process 700 may begin at step/operation 606 of process 600 in which the process 600 includes receiving an item submission from a submitting member. In some examples, each item submission may authorize an intermediate payment transaction in accordance with one or more preauthorization criteria. The preauthorization criteria, for example, may preauthorize an automatic transfer of funds from a submitting member account to an intermediate (e.g., escrow) account in the event that a submission value achieves a hidden and/or visible locking threshold.

In some embodiments, the process 700 includes, at step/operation 702, determining whether the submission value of the item submission input achieves a visible and/or hidden value threshold associated with the data item. For example, the collaboration platform 102 may compare the submission value to the visible and/or hidden value thresholds. In the event that the submission value does achieve at least one of the value thresholds, the process 700 may proceed to step/operation 704. Otherwise, the process 700 may return to step/operation 608 of process 600 in which the process 600 includes providing a submission alert to a listing member associated with the data item.

In some embodiments, the process 700 includes, at step/operation 704, locking the data item. For example, responsive to a determination that the submitted value satisfies a locking threshold (e.g., of a hidden and/or visible submission locking value), the collaboration platform 102 may update an item availability of the data item to automatically lock the data item from receiving subsequent submissions. In some examples, updating the item availability of the data item may include modifying the item status to reflect an unavailable status for the data item. In some examples, responsive to the determination that the submitted value satisfies the locking threshold, the collaboration platform 102 may modify an interactivity parameter of the interactive submission icon to disable a subsequent item submission input.

In some embodiments, responsive to the determination that the submitted value satisfies the locking threshold, the collaboration platform 102 may generate a candidate distributed ledger entry indicative of a locking event and/or one or more characteristics thereof (e.g., a time, a submitting member, a submitted value, the locking threshold, etc.) and provide the candidate distributed ledger entry to one or more distributed devices, as described herein with reference to step/operation 414 of FIG. 4.

FIG. 8 is a flowchart diagram of an example process 800 for improving safety in a peer-to-peer digital marketplace in accordance with some embodiments discussed herein. The flowchart depicts a temporary location tracking process 800 for selectively and automatically tracking a member location during an exchange between peers within a peer-to-peer digital marketplace. The process 800 may be implemented by one or more computing devices, entities, and/or systems described herein. For example, via the various steps/operations of the process 800, the collaboration platform 102 may leverage various computing functionalities to enhance safety within a collaborative computing environment. By doing so, the process 800 enables the improved peer-to-peer digital collaboration techniques that directly address technical challenges within the field of e-commerce.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

The process 800 may begin at step/operation 610 of process 600 in which the process 600 includes receiving a submission response that identifies an acceptance of an item submission input.

In some embodiments, the process 800 includes, at step/operation 802, providing one or more selectable location icons to at least one member to an accepted exchange. The collaboration platform 102, for example, may provide the one or more selectable location icons to a listing member, via a listing member computing device, and/or the submitting member, via a submitting member computing device. By way of example, the collaboration platform 102 may provide for display, through the location interface screen, one or more selectable location icons that respectively identify one or more locations for accessing an item corresponding to the data item. As described herein, the one or more locations may be assessed and selected as one or more safe locations between a listing and submitting user.

In some embodiments, the process 800 includes, at step/operation 804, receiving a location selection from the at least one member to the accepted exchange. The collaboration platform 102, for example, may receive user input that identifies a selection of at least one of the one or more selectable location icons. In this manner, the collaboration platform 102 may receive, through the location interface screen, a location selection identifying an exchange location of the one or more locations. In some examples, the location interface screen may be provided for display in response to an inspection attribute associated with the data item. An example location interface screen is provided with reference to FIG. 10D.

In some embodiments, the collaboration platform 102 provides one or more instructions to a listing member associated with the data item and a submitting member associated with the item submission input in response to the location selection. The one or more instructions may reflect an exchange time and/or exchange address for an inspection and/or pick up of the item.

In some embodiments, responsive to the selection of the exchange location, the collaboration platform 102 may generate a candidate distributed ledger entry indicative of the selected location and/or one or more characteristics thereof (e.g., an address, exchange time, etc.) and provide the candidate distributed ledger entry to one or more distributed devices, as described herein with reference to step/operation 414 of FIG. 4.

In some embodiments, the process 800 includes, at step/operation 806, receiving a location tracking request. The collaboration platform 102, for example, may receive the location tracking request from at least one member to the accepted exchange. In some examples, the location interface screen may include a location tracking request icon. The collaboration platform 102 may receive, through the location interface screen, a selection of the location tracking request icon.

In some embodiments, responsive to the location tracking request, the collaboration platform 102 may generate a candidate distributed ledger entry indicative of an scheduled exchange for the data item and/or one or more characteristics thereof (e.g., an exchange time, a submitting member, a listing member, the exchange location, etc.) and provide the candidate distributed ledger entry to one or more distributed devices, as described herein with reference to step/operation 414 of FIG. 4.

In some embodiments, the process 800 includes, at step/operation 808, determining whether a current time is within a time window corresponding to the exchange. In the event that the current time is within the time window, the process 800 may proceed to step/operation 810. Otherwise, the process may wait for the time window to start and/or proceed to step/operation 612 of process 600 after the time window has elapsed.

In some embodiments, the process 800 includes, at step/operation 810, receiving a location data. The collaboration platform 102, for example, may receive the location data from at least one of the member computing devices of the members to the accepted exchange. In some examples, responsive to the selection of a location tracking request icon and/or based on a proximity of a current time to an exchange time, the collaboration platform 102 may receive (i) listing member location data from a listing member computing device associated with the listing member and/or (ii) submitting member location data from a submitting member computing device associated with the submitting member. In some examples, the collaboration platform 102 may temporarily provide (i) the listing member location data to the submitting member computing device and/or (ii) the submitting member location data to the listing member computing device.

In some embodiments, the collaboration platform 102 may receive a request selection of an exchange location and permission from two or more member computing devices associated with the exchange to provide mutual location tracking data as the two or more member computing devices move toward the exchange location. In some examples, the collaboration platform 102 may initiate a safety verification function upon arrival of the two or more member computing devices to the exchange location. In some examples, the exchange location is selected based on a location of each of the two or more member computing devices and/or at predesignated candidate exchange locations. In some examples, a safety verification may include requesting a member computing device to provide one or more gestures, voice commands, and/or the like.

In some embodiments, the collaboration platform 102 may generate a candidate distributed ledger entry including time-stamped location data for the listing and submitting members and provide the candidate distributed ledger entry to one or more distributed devices, as described herein with reference to step/operation 414 of FIG. 4.

In some embodiments, the process 800 includes, at step/operation 812, monitoring the location data for a location anomaly. The collaboration platform 102, for example, may process the location data to detect a location anomaly based on one or more anomaly criteria.

In some embodiments, the collaboration platform 102 may generate a candidate distributed ledger entry indicative of a location anomaly and/or one or more characteristics thereof (e.g., a time, a submitting member, a listing member, an exchange location, etc.) and provide the candidate distributed ledger entry to one or more distributed devices, as described herein with reference to step/operation 414 of FIG. 4.

FIG. 9 is a flowchart diagram of an example process 900 for enforcing accountability in a peer-to-peer digital marketplace in accordance with some embodiments discussed herein. The flowchart depicts a rating enforcement process 900 that leverages a selective account locking mechanism to incentivize peer-to-peer ratings between peers within a peer-to-peer digital marketplace. The process 900 may be implemented by one or more computing devices, entities, and/or systems described herein. For example, via the various steps/operations of the process 900, the collaboration platform 102 may leverage various computing functionalities to enhance reliability and transparency within a collaborative computing environment. By doing so, the process 900 enables the improved peer-to-peer digital collaboration techniques that directly address technical challenges within the field of e-commerce.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

The process 900 may begin at step/operation 614 of process 600 in which the process 600 includes locking a member account after a completed exchange.

In some embodiments, the process 900 includes, at step/operation 902, providing a rating screen to at least one member of an exchange. The collaboration platform 102, for example, may trigger a display of the rating screen via the member computing device associated with the at least one member. An example, rating screen is illustrated with reference to FIG. 10E.

In some embodiments, the process 900 includes, at step/operation 904, receiving a rating for an exchange. The collaboration platform 102, for example, may receive the rating for the exchange through user input to the rating screen.

In some embodiments, the collaboration platform 102 may generate a candidate distributed ledger entry indicative of a rating event and/or one or more characteristics thereof (e.g., a time, a submitting member, a listing member, the rating, etc.) and provide the candidate distributed ledger entry to one or more distributed devices, as described herein with reference to step/operation 414 of FIG. 4.

In some embodiments, the process 900 includes, at step/operation 906, unlocking a member account in response to the rating. The collaboration platform 102, for example, may provide access to the member account responsive to the rating.

Some techniques of the present disclosure enable the generation of action outputs that may be performed to initiate one or more real world actions to achieve real-world effects. The exchange facilitation techniques of the present disclosure, for example, may be used, applied, and/or otherwise leveraged to facilitate a real-world and/or digital exchange between two members within a hybrid ecosystem that marries a digital and physical marketplace. In some examples, the hybrid ecosystem may facilitate automated physical actions responsive to digital interactions between members within the ecosystem. The automated physical actions, for example, may include one or more automated alerts, such as those designed to ensure safety during a physical touchpoint between two previously unacquainted individuals. By way of example, the collaboration platform 102 may provide one or more control instructions to a member computing device (and/or a third-party computing entity) to trigger one or more tactile, auditory, and/or visual alerts in response to a location anomaly.

In addition, or alternatively, the collaboration platform 102 may initiate one or more actions across one or more location-specific devices that are physically located at an exchange location. For instance, an exchange location may include one or more smart lights, sirens, emergency towers, and/or the like. In some examples, in response to a location anomaly, the collaboration platform 102 may activate (e.g., via one or more connected APIs, etc.) an emergency pole physically located within a proximity to the exchange location. In some examples, the emergency pole may be deactivated in response to a verification of a member's safety (e.g., through voice and/or image authentication, etc.).

### IX. Example Exchange User Interfaces

The user interface screens illustrated in FIGS. 10A-E are provided to facilitate a peer-to-peer exchange through multiple member computing devices individually operating within a digital ecosystem. The user interface screens are provided as just one set of examples. In some examples, a member computing device is configured to generate and/or select user interface screens based on a user input provided throughout an exchange process. In addition, or alternatively, a member computing device may be configured to access one or more user interface screens hosted by the collaboration computing system. In such a case, the collaboration computing system may receive a request from the member computing device and grant access to data representative of a particular user interface screen in response to the request.

The user interface screens provided by FIGS. 10A-E may be rearranged and/or branch out from each other to form a plurality of exchange flow processes in which each user interface screen may depend on user input provided in a preceding user interface screen. At each user interface screen, data may be displayed for facilitate a peer-to-peer exchange. Thus, each user interface screen and/or the order in which each user interface screen is displayed may be based on the peer-to-peer exchange.

FIG. 10A specifically illustrates an example browsing interface screen 308 to be displayed to the member as the member initiates a potential exchange process. The browsing interface screen 308, for example, may include a query page that allows a member to select one or more search criteria for a one-time and/or continuous time search. The search criteria, for example, may include a search radius, an item category, a price ranges, one or more keywords and/or phrases, and/or the like. In response to the search criteria, a set of data items corresponding to the criteria may be identified and provided for display. Although not show, in some examples, the browsing interface screen 308 may include an option for a one-time or continuous search. In response to a selection of a continuous search, the set of data items corresponding to the criteria may be dynamically updated based on new data item listings and/or a movement of the member computing device over time.

FIG. 10B specifically illustrates an example item interface screen 310 to be displayed to the member in response selection of a data item. The item interface screen 310, for example, may include a data item listing page that includes one or more visible attributes of the data item and/or one or more interactive icons for interacting with the data item. The one or more visible attributes may include any of the attributes described herein, such as one or more item images, an item description, listing member rating, and/or the like. Although not shown in the specific example, the item interface screen 310 may include an indicator that the data item is associated with a hidden submission locking value. In addition, or alternatively, the item interface screen 310 may include one or more other, visible value parameters, such as a minimum submission value and/or visible locking submission value. In some examples, the item interface screen 310 may include one or more interactive icons, such a listing member info icon and/or a submission icon. The listing member info icon may redirect a member to a listing member's profile page and/or rating history. The submission icon may provide an item submission to the data item.

FIG. 10C specifically illustrates an example submission alert screen 1006 to be displayed to a listing member in response to an item submission from a submitting member. The submission alert screen 1006 may include an alert message that identifies a new item submission for a data item listed by the listing member. The listing member may select a view icon to view an item submission details page corresponding to the item submission. The item submission details page may include the visible and hidden data item attributes corresponding the data item, as well as, submitting member information. In some examples, submission alert screen 1006 may include one or more interactive icons, such a submission member info icon and/or a submission response icon. The submitting member info icon may redirect a member to a submitting member's profile page and/or rating history. The submission response icon may provide a submission response to the submitting member.

FIG. 10D specifically illustrates an example location interface screen 314 to be displayed to a submitting and/or listing member in response to an acceptance of an item submission. The location interface screen 314 may include a notification that an item submission is accepted, one or more attributes of the data items, such as that an inspection is required, and/or one or more selectable icons. The selectable icons, for example, may include a plurality of selectable location icon corresponding to one or more predesignated safe location. Each of the selectable location icons may include a corresponding location description that may describe one or more safety and/or location features of a particular location. The safety features, for example, may describe one or more location-specific safety devices (e.g., surveillance cameras, emergency towers, etc.), one or more crime statistics, and/or the like. In some examples, the selectable icons may include a request icon for tracking a member's location during a physical exchange. In addition, or alternatively, the selectable icons may include a member info icon that may redirect a member to another member's profile page and/or rating history.

FIG. 10E specifically illustrates an example rating screen 1010 to be displayed to a submitting and/or listing member in response to an exchange confirmation. The rating screen 1010, for example, may include an automatic account locking screen that disables access to a member's account until the member provides a rating for the exchange. In some examples, responsive to the input of a rating, the rating screen 1010 may transition to a rating history for the rated member. The member may then be access to the member's account.

### X. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for leveraging integrated blockchain platform mechanisms to establish secure network exchanges through a combination of centralized and distributed devices, the computer-implemented method comprising:
receiving, by one or more processors and through a browsing interface screen, an item selection input corresponding to a data item, wherein (i) the data item comprises one or more visible attributes and one or more hidden attributes and (ii) one of the one or more hidden attributes identifies a locking threshold for the data item;
responsive to the item selection input, providing for display, by the one or more processors and through an item interface screen, the one or more visible attributes for the data item;
receiving, by the one or more processors and through the item interface screen, an item submission input that identifies a submitted value for the data item;
responsive to a determination that the submitted value satisfies the locking threshold, updating, by the one or more processors, an item availability of the data item;
generating, by the one or more processors, a candidate distributed ledger entry indicative of the data item, a listing member associated with the data item, the item submission input, and a submitting member associated with the item submission input; and
providing, by the one or more processors, the candidate distributed ledger entry to one or more distributed computing devices, wherein the candidate distributed ledger entry is added to a platform distributed ledger in accordance with a voting mechanism corresponding to the platform distributed ledger.

2. The computer-implemented method of claim 1, wherein:
(i) the one or more visible attributes comprise an item status that identifies an interactivity the data item,
(ii) the item status for the data item reflects an available status for the data item, and
(iii) updating the item availability of the data item comprises modifying the item status to reflect an unavailable status for the data item.

3. The computer-implemented method of claim 1, wherein the one or more visible attributes comprise a locking indicator attribute corresponding to the locking threshold and visually indicating that the data item is associated with the locking threshold without identifying a hidden submission locking value of the locking threshold.

4. The computer-implemented method of claim 1, wherein the item submission input is provided through an interactive submission icon of the item interface screen and the computer-implemented method further comprises:
responsive to the determination that the submitted value satisfies the locking threshold, modifying an interactivity parameter of the interactive submission icon to disable a subsequent item submission input.

5. The computer-implemented method of claim 1, wherein the data item corresponds to a digital item and the candidate distributed ledger entry comprises a digital watermark for the digital item.

6. The computer-implemented method of claim 5, wherein the candidate distributed ledger entry comprises a plurality of Internet Protocol (IP) addresses respectively corresponding to the listing member, the submitting member, and a third-party computing entity that facilitates a download of the digital item.

7. The computer-implemented method of claim 1, further comprising:
providing for display, through a location interface screen, one or more selectable location icons that respectively identify one or more locations for accessing an item corresponding to the data item;
receiving, through the location interface screen, a location selection identifying a location of the one or more locations; and
providing one or more instructions to a listing member associated with the data item and a submitting member associated with the item submission input.

8. The computer-implemented method of claim 7, wherein:
(i) the location interface screen is provided for display in response to an inspection attribute associated with the data item; and
(ii) the one or more instructions reflect an exchange time and exchange address for an inspection of the item.

9. The computer-implemented method of claim 8, wherein the location interface screen comprises a location tracking request icon, and the computer-implemented method further comprises:
receiving, through the location interface screen, a selection of the location tracking request icon;
responsive to the selection and based on a proximity of a current time to the exchange time, receiving (i) listing member location data from a listing member computing device associated with the listing member and (ii) submitting member location data from a submitting member computing device associated with the submitting member; and
temporarily providing (i) the listing member location data to the submitting member computing device and (ii) the submitting member location data to the listing member computing device.

10. The computer-implemented method of claim 1, wherein:
(i) the one or more visible attributes for the data item comprise a minimum submission value, a current submission value, and a visible locking submission value, and
(ii) the locking threshold comprises a hidden submission locking value that is between the minimum submission value and the visible locking submission value.

11. The computer-implemented method of claim 1, wherein the one or more visible attributes comprise a member rating identifier for a listing member corresponding to the data item.

12. The computer-implemented method of claim 1, further comprising:
performing an initial transaction operation to (i) deduct the submitted value from a submitting account associated with a submitting member and (ii) store the submitted value in an intermediary account;
receiving a completed transaction input from the submitting member; and
responsive to the completed transaction input, performing a secondary transaction operation to (i) deduct the submitted value from the intermediary account and (ii) provide the submitted value to a listing account associated with a listing member.

13. The computer-implemented method of claim 12, wherein the completed transaction input is responsive to a verified physical inspection of a physical item corresponding to the data item.

14. A computing system for leveraging integrated blockchain platform mechanisms to establish secure network exchanges through a combination of centralized and distributed devices, the computing system comprising memory and one or more processors communicatively coupled to the memory, the one or more processors configured to:
receive, through a browsing interface screen, an item selection input corresponding to a data item, wherein (i) the data item comprises one or more visible attributes and one or more hidden attributes and (ii) one of the one or more hidden attributes identifies a locking threshold for the data item;
responsive to the item selection input, provide for display, through an item interface screen, the one or more visible attributes for the data item;
receive, through the item interface screen, an item submission input that identifies a submitted value for the data item;
responsive to a determination that the submitted value satisfies the locking threshold, update an item availability of the data item;
generate a candidate distributed ledger entry indicative of the data item, a listing member associated with the data item, the item submission input, and a submitting member associated with the item submission input; and
provide the candidate distributed ledger entry to one or more distributed computing devices, wherein the candidate distributed ledger entry is added to a platform distributed ledger in accordance with a voting mechanism corresponding to the platform distributed ledger.

15. The computing system of claim 14, wherein:
(i) the one or more visible attributes comprise an item status that identifies an interactivity the data item,
(ii) the item status for the data item reflects an available status for the data item, and
(iii) updating the item availability of the data item comprises modifying the item status to reflect an unavailable status for the data item.

16. The computing system of claim 14, wherein the one or more visible attributes comprise a locking indicator attribute corresponding to the locking threshold and visually indicating that the data item is associated with the locking threshold without identifying a hidden submission locking value of the locking threshold.

17. The computing system of claim 14, wherein the item submission input is provided through an interactive submission icon of the item interface screen and the one or more processors are further configured to:
responsive to the determination that the submitted value satisfies the locking threshold, modify an interactivity parameter of the interactive submission icon to disable a subsequent item submission input.

18. One or more non-transitory computer-readable storage media for leveraging integrated blockchain platform mechanisms to establish secure network exchanges through a combination of centralized and distributed devices, the one or more non-transitory computer-readable storage media comprising instructions that, when executed by one or more processors, cause the one or more processors to:
receive, through a browsing interface screen, an item selection input corresponding to a data item, wherein (i) the data item comprises one or more visible attributes and one or more hidden attributes and (ii) one of the one or more hidden attributes identifies a locking threshold for the data item;
responsive to the item selection input, provide for display, through an item interface screen, the one or more visible attributes for the data item;
receive, through the item interface screen, an item submission input that identifies a submitted value for the data item;
responsive to a determination that the submitted value satisfies the locking threshold, update an item availability of the data item;
generate a candidate distributed ledger entry indicative of the data item, a listing member associated with the data item, the item submission input, and a submitting member associated with the item submission input; and
provide the candidate distributed ledger entry to one or more distributed computing devices, wherein the candidate distributed ledger entry is added to a platform distributed ledger in accordance with a voting mechanism corresponding to the platform distributed ledger.

19. The one or more non-transitory computer-readable storage media of claim 18, wherein the instructions further cause the one or more processors to:
perform an initial transaction operation to (i) deduct the submitted value from a submitting account associated with a submitting member and (ii) store the submitted value in an intermediary account;
receive a completed transaction input from the submitting member; and
responsive to the completed transaction input, perform a secondary transaction operation to (i) deduct the submitted value from the intermediary account and (ii) provide the submitted value to a listing account associated with a listing member.

20. The one or more non-transitory computer-readable storage media of claim 18, wherein the instructions further cause the one or more processors to:
provide for display, through a location interface screen, one or more selectable location icons that respectively identify one or more locations for accessing an item corresponding to the data item;
receive, through the location interface screen, a location selection identifying a location of the one or more locations; and
provide one or more instructions to a listing member associated with the data item and a submitting member associated with the item submission input.
